(19) United States
(12) Patent Application Publication
(10) Pub. No.: US 2017/0129187 A1
(43) Pub. Date: May 11, 2017

(54) THREE DIMENSIONAL MOLDING APPARATUS AND CONTROL PROGRAM

(71) Applicant: KONICA MINOLTA, INC., Tokyo (JP)

(72) Inventors: Yoshiyuki HASHIMOTO, Tokyo (JP); Shigeki TAKENOUCHI, Tokyo (JP)

(73) Assignee: KONICA MINOLTA, INC., Tokyo (JP)

(21) Appl. No.: 15/413,489

(22) Filed: Jan. 24, 2017

Related U.S. Application Data
(62) Division of application No. 13/571,716, filed on Aug. 10, 2012.

(30) Foreign Application Priority Data
Aug. 25, 2011 (JP) 2011-184035
Oct. 14, 2011 (JP) 2011-226528

(51) Int. Cl. B29C 67/00; B33Y 50/02

(52) U.S. Cl. CPC B29C 67/0088; B29C 67/0081; B29C 67/0055; B29C 67/0077; B33Y 50/02

(57) ABSTRACT

A non-transitory computer-readable recording medium recorded therein a program that causes a computer to enable functions of a) a three-dimensional object molding apparatus configured to mold a three-dimensional object by sequentially stacking a molding material, or b) a control section for controlling the three-dimensional object molding apparatus. The functions include a data input section to input a three-dimensional shape information of a target to be molded and a molding parameter generating section that calculates a filling rate indicating a degree of density of the molding material, or a mixture proportion of a plurality of the molding materials, based on the information necessary to produce a desired molded object and configured to generate molding information for stacking the molding material in accordance with the calculated filling rate and mixture proportion. The functions also include a molding section to stack the molding material in accordance with the molding information.

This application is a divisional of U.S. patent application Ser. No. 13/571,716, filed Aug. 10, 2012, and claims priority under 35 U.S.C. §119 to Japanese Patent Application No. 2011-184035 filed on Aug. 25, 2011, and to Japanese Patent Application No. 2011-226528 filed on Oct. 14, 2011, in Japan Patent Office, the entire contents of which is hereby incorporated by reference.

### TECHNICAL FIELD

The present invention relates to a three-dimensional object molding apparatus and a control program, specifically relating to a three-dimensional object molding apparatus for molding a three-dimensional object in which the weight of a target to be molded is reproduced or the weight balance of the three-dimensional object is adjusted, and a control program to generate information for molding a three-dimensional object in which the weight of a target to be molded is reproduced or the weight balance of the three-dimensional object is adjusted.

### BACKGROUND OF THE INVENTION

As a technology for molding a three-dimensional object, a technology that is called “Rapid Prototyping (RP)” is well known. This technology is a technology in which a cross-sectional shape sliced in a stacking direction is calculated via STL (Standard Triangulated Language) format data which describes a surface of single three-dimensional shape as a gathering of triangles, and a three-dimensional object is molded by forming each layer in accordance with the shape. Also, a method such as a fused deposition molding (FDM) method, an inkjet method, an inkjet binder method, an optical molding method (SL: Stereo Lithography), a powder sintering method (SLS: Selective Laser Sintering), or the like, is known as a method for molding a three-dimensional object.

As an apparatuses for molding a three-dimensional object by using such method described above, as an example, an apparatus has been disclosed in Japanese Patent No. 3433219 in which a three-dimensional object is molded from a material in which a binder, such as polyethylene, and a metal alloy, such as stainless, titanium, or the like, are compounded by a desired fraction in advance. Also, a product has been sold which includes a plurality of heads capable of ejecting a molding material, and molds an object by appropriately ejecting different types of materials from each of the heads. In this product, it is possible to mold a three-dimensional object by appropriately ejecting a different material from a different head selectively so as to change colors and textures by the difference in molding materials for respective areas and parts.

### SUMMARY OF THE INVENTION

Conventionally, there have been available technologies for molding a three-dimensional object in which a three-dimensional shape of a target to be molded is simply reproduced. However, there is no available molding technology in which the purpose of utilization of the three-dimensional object, after the three-dimensional object is molded, is considered. For example, in a case in which a mock-up is molded via a conventional three-dimensional object molding apparatus, it is possible to reproduce colors and textures. However, there is a problem that it is difficult to reproduce the weight of the target to be molded because the weight is determined by the quality and volume of the molding materials.

Also, for a molded object, specifically for a molded object for display purpose, a stable self-standing ability is an important factor, and therefore, conventionally, in a case in which three-dimensional (3D) data is designed by using a 3D-CAD (Computer Aided Design) or the like, the three-dimensional data itself is made to be a weight-balanced appearance shape in advance, or a hollow is provided inside the molded object, and at a 3D printer side, an self-standing molded object is obtained by faithfully molding the internal and external shapes including internal structures thereof, having been input.

In this way, a conventional 3D printer is specialized in reproducing a 3D shape faithfully, and has no functions for adjusting weight balance, and therefore, there are cases in which a molded object is unstable and is not able to stand by it self, or tends to fall down easily, due to the reasons attributable to the shape of the molded object such as “a ground contacting area is small”, “the molded object inclines”, and the like.

Also, in a case in which, because the main-body of a molded object alone does not stand by itself due to the shape of the molded object, another molded object, which is placed on the same or another display stand (support stand) for the molded object, is to be molded, it is difficult to accurately conform the supporting point of the main-body of the molded object by the display stand to the portion (the position of the center of gravity) which can stably support the main-body of the molded object, and if the supporting point is set by giving priority to the appearance of the molded object at the time of display, the molded object may become unstable because the supporting point may deviate from the position of the center of gravity. Further, in a case in which a molded object, which is to be used by hanging, is to be molded, it is also difficult to accurately conform the position of suspension to the portion (the position of the center of gravity) which can stably support the main-body of the molded object, and if the point of suspension is set by giving priority to the appearance of the molded object at the time of display, the molded object may become unstable because the supporting point may deviate from the position of the center of gravity.

The present invention has been achieved in consideration of the above problems, and it is one of the main objects to provide a three-dimensional object molding apparatus for molding a three-dimensional object, in which the weight of a target to be molded has been reproduced, and a control program to generate information for molding a three-dimensional object, in which the weight of a target to be molded has been reproduced. Also, it is another one of the main objects to provide a three-dimensional object molding apparatus for molding a three-dimensional object, in which the weight balance of a target to be molded has been adjusted, and a control program to generate information for molding a three-dimensional object, in which the weight balance of a target to be molded has been adjusted.

A three-dimensional object molding apparatus to mold a three-dimensional object by sequentially stacking a molding material reflecting one aspect of the present invention includes at least, but is not limited to: 1) a data input section configured to input an information including a three-dimensional shape information of a target to be molded necessary to produce a desired molded object; 2) a molding material database configured to store a weight information per unit volume of one or a plurality of the molding materials to be used for molding; 3) a molding parameter generating section configured: a) to calculate a filling rate indicating a degree of denseness/sparseness of the molding material, or a mixture proportion of a plurality of the molding materials, based on the information necessary to produce a desired molded object, having been obtained from the data input section, and the weight information of the one or plurality of the molding materials, having been obtained from the molding material database; and b) to generate a molding information for stacking the molding material in accordance with the filling rate and mixture proportion having been calculated; and 4) a molding section configured to stack the molding material in accordance with the molding information.

Preferably, the desired molded object is a molded object having an identical weight as that of the target to be molded; to the data input section, a weight information per unit volume of the target to be molded, or a weight information of an entire weight of the target to be molded is input as a necessary information to produce the desired molded object; and the molding parameter generating section is configured to generate a molding information capable of producing a molded object having the identical weight as that of the target to be molded, based on the shape information and weight information of the target to be molded, having been obtained from the data input section, and the weight information of the one or plurality of molding materials, having been obtained from the molding material database.

Preferably, the desired molded object is a molded object that is in a stable condition with respect to a specific supporting direction, and the three-dimensional object molding apparatus further includes: a weight balance calculating section configured: a) to obtain a position of the center of gravity of a molded object having an identical shape as that of the target to be molded based on the shape information of the target to be molded, having been obtained from the data input section; and b) to calculate a weight distribution of each portion of the molded object so that the molded object is in a stable condition with respect to a specific supporting direction, wherein the molding parameter generating section is configured to generate a molding information capable of producing a molded object which is in a stable condition with respect to a specific supporting direction, based on the shape information of the target to be molded, having been obtained from the data input section, the weight distribution information having been calculated via the weight balance calculating section, and the weight information of the one or plurality of molding materials, having been obtained from the molding material database.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIGS. 1a, 1b, 1c, 1d, and 1e are explanatory diagrams illustrating variations of methods, by classification, for reproducing a weight of a molded object.

FIGS. 2a, 2b, and 2c each is a diagram illustrating an example of a structure for reproducing the weight by a degree of denseness/sparseness of a molding material.

FIGS. 3a and 3b are diagrams schematically illustrating examples of structures of heads in a case in which the weight is reproduced by using a plurality of molding materials.

FIG. 4 is a block diagram illustrating a structure of a three-dimensional object molding apparatus according to an example of the present invention.

FIG. 5 is a flow chart explaining steps for molding of a three-dimensional object (in a case of reproduction of weight) according to an example of the present invention.

FIG. 6 is a diagram illustrating a method for reproducing a weight of a molded object (in a case in which one type of molding material is used, and the weight is reproduced by a uniform filling rate).

FIG. 7 is a diagram illustrating a method for reproducing weight of a molded object (in a case in which one type of molding material is used, and weight is reproduced by changing filling rate on a part to part basis).

FIG. 8 is a diagram illustrating a method for reproducing a weight of a molded object (in a case in which a plurality of types of molding materials is used, and the weight is reproduced by a uniform mixture proportion).

FIG. 9 is a diagram illustrating a method for reproducing a weight of a molded object (in a case in which a plurality of types of molding materials is used, and the weight is reproduced by changing mixture proportion on a part to part basis).

FIGS. 10a, 10b, 10c, and 10d each is a diagram illustrating a method for reproducing a position of the center of gravity of a molded object (in a case in which one type of molding material is used, and the position of the center of gravity is reproduced by changing a filling rate).

FIGS. 11a, 11b, 11c, and 11d each is a diagram illustrating a method for reproducing a position of the center of gravity of a molded object (in a case in which a plurality of types of molding materials is used, and the position of the center of gravity is reproduced by changing the molding materials).

FIG. 12 is a diagram illustrating a method for reproducing a weight of a molded object (in a case in which a molded object is divided into regions of micro-volumes, and the weight is reproduced on a region to region basis).

FIG. 13 is a diagram illustrating a method for reproducing a weight of a molded object (in a case in which the weight is reproduced by using a molding material which is lighter than a part).

FIG. 14 is a diagram illustrating a method for reproducing a texture of a molded object (in a case in which a surface portion is molded by a uniform filling rate or mixture proportion).

FIG. 15 is a diagram illustrating a method for reproducing a weight of a molded object (in a case in which the weight is adjusted per layer, per line, or per dot).

FIGS. 16a and 16b each is a diagram illustrating a method for reproducing a weight of a molded object (in a case in which the weight is adjusted per layer).

FIGS. 17a and 17b each is a diagram illustrating a method for reproducing a weight of a molded object (in a case in which the weight is adjusted per line).

FIGS. 18a and 18b each is a diagram illustrating a method for reproducing a weight of a molded object (in a case in which the weight is adjusted per dot).

FIG. 19 is a diagram schematically illustrating a method for reproducing a moment of inertia of a molded object.

FIGS. 20a and 20b are explanatory diagrams illustrating variations of methods for reproducing a moment of a molded object.

FIG. 21 is a flow chart explaining steps for molding of a three-dimensional object (in a case of reproduction of weight and moment) according to an example of the present invention.

FIGS. 22a, 22b, 22c, 22d, and 22e each is a diagram schematically illustrating a conventional method (fused deposition molding method) for molding a three-dimensional object.

FIG. 23 is a diagram schematically illustrating a conventional method (inkjet method) for molding a three-dimensional object.

FIG. 24 is a diagram schematically illustrating a conventional method (inkjet binder method) for molding a three-dimensional object.

FIG. 25 is a diagram schematically illustrating a conventional method (optical molding method) for molding a three-dimensional object.

FIG. 26 is a diagram schematically illustrating a conventional method (powder sintering method) for molding a three-dimensional object.

FIGS. 27a, 27b, and 27c are explanatory diagrams illustrating variations of methods, by classification, for reproducing a weight balance of a molded object.

FIGS. 28a, 28b, and 28c each is a diagram illustrating an example of a structure for adjusting the weight balance by a degree of denseness/sparseness of a molding material.

FIGS. 29a and 29b are diagrams schematically illustrating examples of structures of heads in a case in which the weight balance is adjusted by using a plurality of molding materials.

FIG. 30 is a block diagram illustrating a structure of a three-dimensional object molding apparatus according to an example of the present invention.

FIG. 31 is a flow chart explaining steps for molding of a three-dimensional object (in a case of adjustment of weight balance) according to an example of the present invention.

FIGS. 32a and 32b are explanatory diagrams illustrating weight balance of an inclined molded object.

FIGS. 33a and 33b are explanatory diagrams illustrating how to obtain a position of the center of gravity.

FIGS. 34a, 34b, and 34c each is an explanatory diagram illustrating a method for adjusting weight balance of an inclined molded object.

FIG. 35 is a diagram illustrating a supporting range corresponding to the position of the center of gravity to maintain the weight balance.

FIG. 36 is a flow chart explaining steps for adjusting the position of the center of gravity to maintain the weight balance.

FIG. 37 is a diagram illustrating the position of the center of gravity to maintain a stable weight balance.

FIG. 38 is a flow chart explaining steps for adjusting the position of the center of gravity to maintain a stable weight balance.

FIG. 39 is a diagram illustrating an example of a molded object supported by one point.

FIG. 40 is a diagram illustrating an example of a molded object supported by a plurality of points.

FIG. 41 is a diagram illustrating an example of a molded object suspended by one point.

FIG. 42 is a diagram illustrating a position of the center of gravity in a case of suspension by a plurality of points.

FIG. 43 is a diagram illustrating an example of a molded object standing by itself in a plurality of figures (postures).

FIG. 44 is a diagram illustrating an example of a molded object standing by itself in a plurality of figures (state of upside down).

FIG. 45 is a diagram illustrating an example of a method for designating a supporting surface.

FIG. 46 is a diagram illustrating an example of a method for designating a supporting surface and a supporting direction.

FIG. 47 is a diagram illustrating another example of the method for designating a supporting surface and a supporting direction.

FIGS. 48a and 48b are diagrams illustrating another example of a method for adjusting weight balance according to the present example.

FIGS. 49a and 49b are diagrams illustrating other examples of methods for adjusting weight balance according to the present example.

### DETAILED DESCRIPTION OF THE PREFERRED EMBODIMENTS

As described in the BACKGROUND OF THE INVENTION, as a technology for molding a three-dimensional object, a technology that is called “Rapid Prototyping (RP)” is well known, and a method such as a fused deposition molding (FDM) method, an inkjet method, an inkjet binder method, an optical molding method (SL), a powder sintering method (SLS), or the like, is known as a method for molding a three-dimensional object.

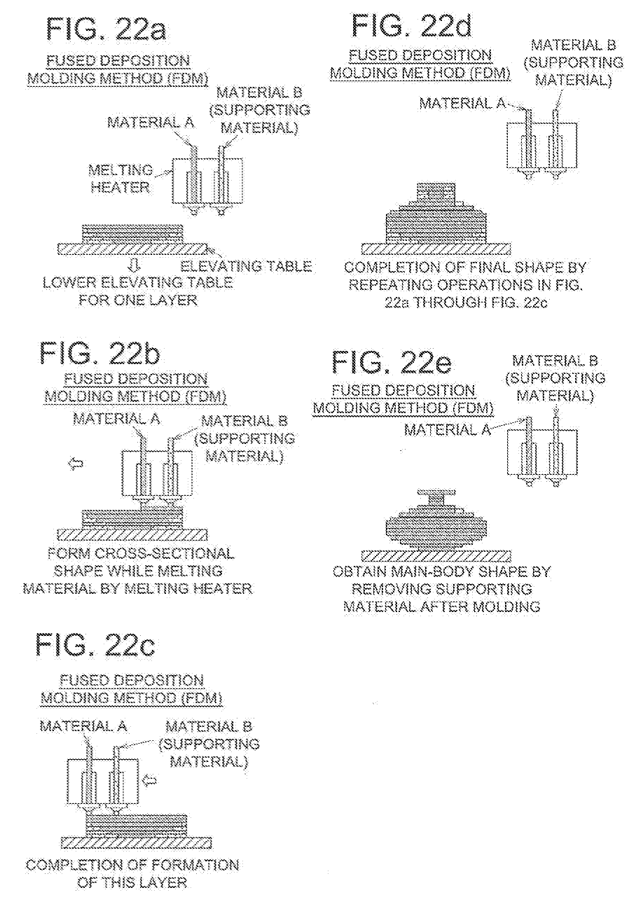

In the fused deposition molding (FDM) method, as illustrated in FIGS. 22a, 22b, 22c, 22d, and 22e, a head moves in a traversable manner in a layer of the same height, and stacks molding materials. For example, a thermoplastic material is heated to become a fluidized state, and a head draws cross-sectional shapes while pushing out the material from one nozzle. Also, as appropriate, a supporting material made of a thermoplastic material is heated and melted, and is pushed out from another nozzle of the head. Then, a thin hardened layer is produced when the supplied materials have cooled down. After repeating these processes, by dissolving and removing the supporting material, a three-dimensional object is molded.

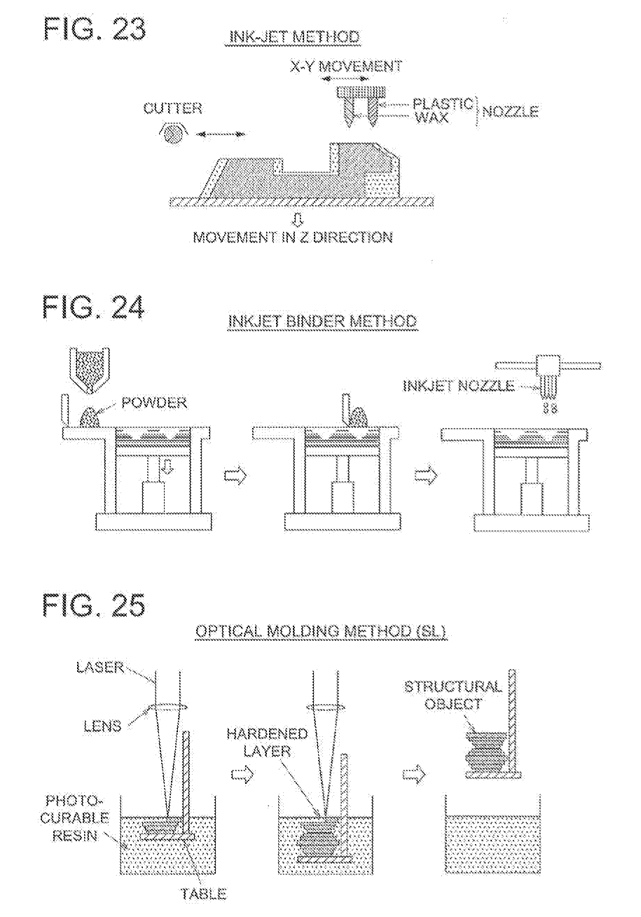

In the inkjet method, as illustrated in FIG. 23, similar to a common inkjet printer using papers, a print-head moves in a y-direction while repeating a reciprocating motion in an x-direction. For example, a thermoplastic material (build material) is heated and melted, and the build material is dropped from one inkjet nozzle in the print-head in accordance with cross-sectional shapes. Also, as appropriate, a supporting material made of a thermoplastic material is heated and melted, and is dropped from another nozzle of the print-head onto the outer circumference and inner circumference of a model. Then, a thin hardened layer is produced when the dropped materials have cooled down, and each time when another layer has been stacked, the upper portion of the layer is removed by cutting. By repeating these processes, a three-dimensional object is molded, and the supporting material is dissolved and removed later.

In the inkjet binder method, as illustrated in FIG. 24, a binder is dropped from above via an inkjet nozzle, in accordance with cross-sectional shapes, onto powders having been bedded so as to produce a thin solidified layer by binding the powders to each other. Then, powders are thinly bedded on the thin solidified layer having been produced, and by repeating these processes, a three-dimensional object is molded.

In the optical molding method, as illustrated in FIG. 25, by scanning a resin solution surface via laser beam in accordance with cross-sectional shapes, hardening of the surface layer and binding with the lower layer are carried out. Then, the table descends in proportion to the thickness of one layer, and by repeating the above-mentioned processes, a three-dimensional object is molded.

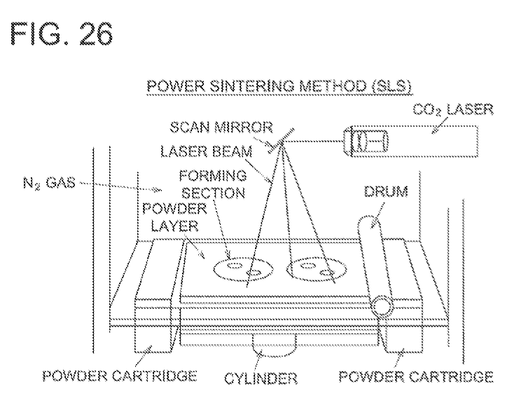

In the powder sintering method, as illustrated in FIG. 26, a powder layer, in which powders are bedded, is scanned from above via an infrared laser beam in accordance with cross-sectional shapes so as to produce a thin solidified layer by sintering the powders to each other. At that time, binding with the lower layer via sintering is also carried out. Then, powders are thinly bedded on the solidified layer, having been produced, and by repeating the above-mentioned processes, a three-dimensional object is molded.

By using such methods, it is possible to produce a three-dimensional object having a physical appearance similar to that of a target to be molded. However, these methods are methods in which a three-dimensional object is molded by using a molding material that has a uniform degree of density. However, these methods are not methods for molding a three-dimensional object having an identical weight as that of the target to be molded, or for molding a three-dimensional object in consideration of weight balance, and therefore, it is difficult not only to reproduce the weight, hold-feeling, or feel to use when the three-dimensional object is held in one's hands, but also to reproduce a three-dimensional object which stands stably by itself in cases in which the target to be molded is an unstable shape. Further, these methods are not methods in which a three-dimensional object is molded so as to have an identical position of the center of gravity and the moment as those of the target to be molded, and therefore, it is difficult to reproduce massive feeling when the molded three-dimensional object is moved even if the molded three-dimensional object has an identical weight as that of the target to be molded.

To solve the abovementioned problems, according to an preferred embodiment of the present invention, a three-dimensional object molding apparatus which is operated via the fused deposition molding (FDM) method, the inkjet method, or the like, is provided with a molding parameter generating section, and the molding parameter generating section determines how to stack molding materials to reproduce the weight, by using the shape information and weight information of a target to be molded. Then, by adjusting filling rates or mixture proportions of the molding materials entirely or partially, the same weight, position of the center of gravity, and moment as those of the target to be molded is realized.

More specifically, based on the weight information of the target to be molded, a three-dimensional object is molded with a uniform ratio of the denseness/sparseness of the molding material for the entire area of the target to be molded so as to adjust the weight of the target to be molded. Or, a three-dimensional object is molded by changing the filling rate of the molding material for each portion of the target to be molded so as to adjust the weight distribution of the target to be molded. Or, a three-dimensional object is molded with a uniform mixture proportion of a plurality of molding materials for the entire area of the target to be molded so as to adjust the weight of the target to be molded. Or, a three-dimensional object is molded by changing the mixture proportion of the plurality of molding materials for each portion of the target to be molded so as to adjust the weight distribution of the target to be molded.

Whereby, it becomes possible to reproduce not only the exterior appearance design, but also the weight, hold-feeling, and feel to use when the molded three-dimensional object is held in one's hands, and therefore, it is possible to provide for the user a molded object which is closer to the actual object.

### EXAMPLE

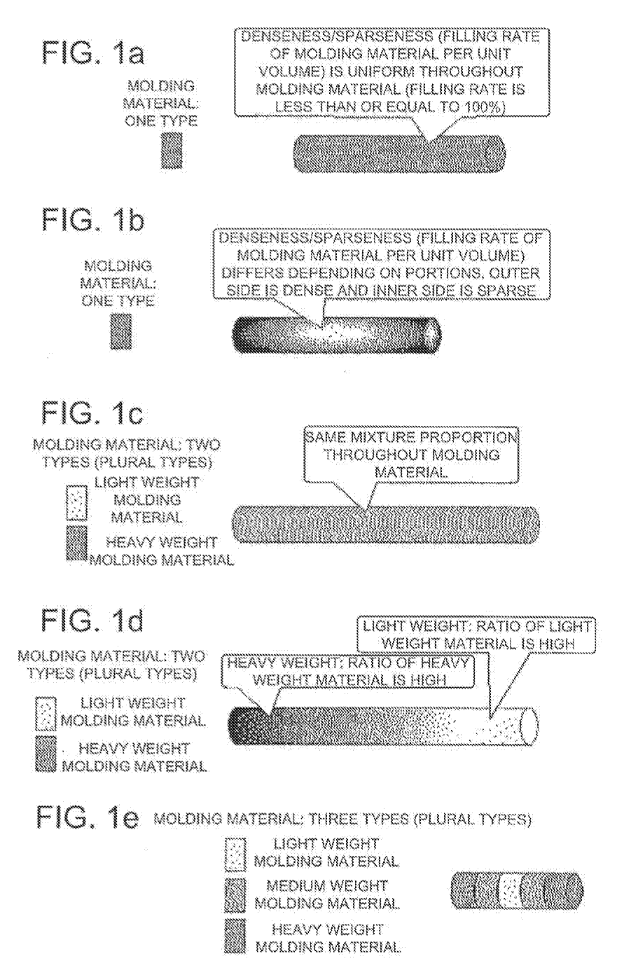

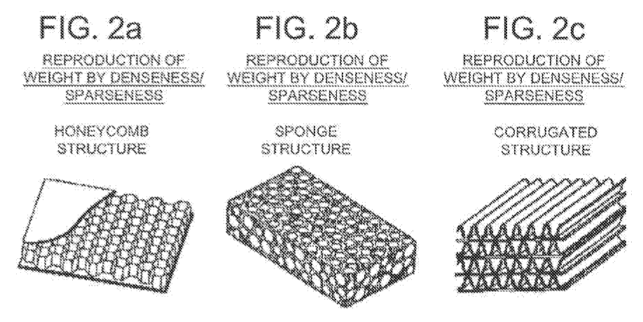

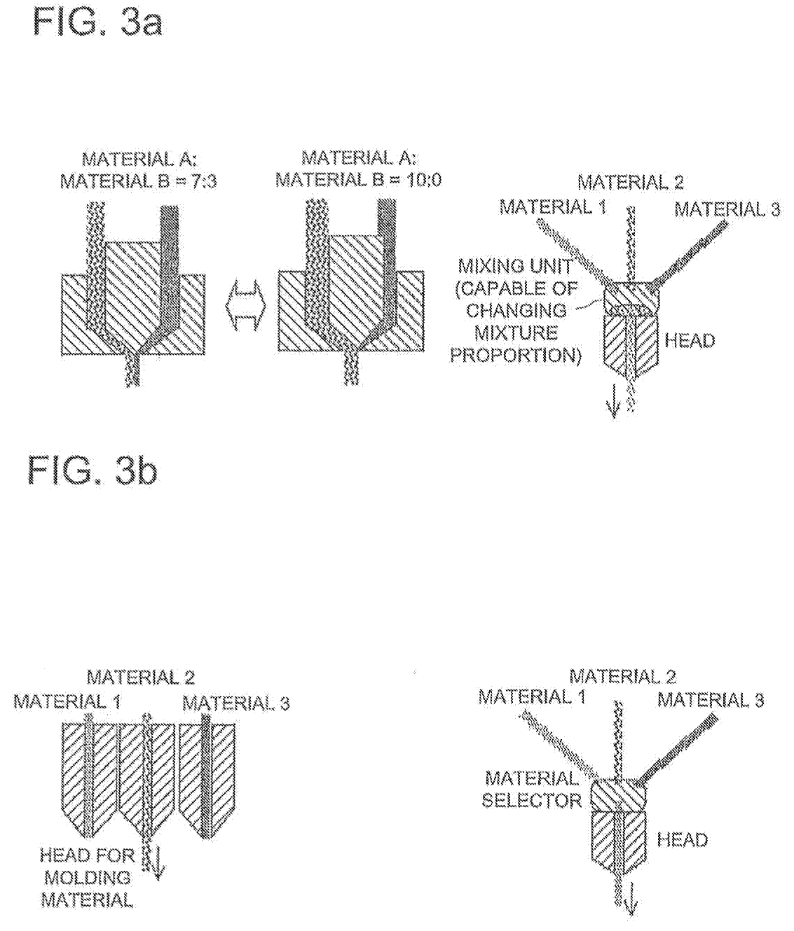

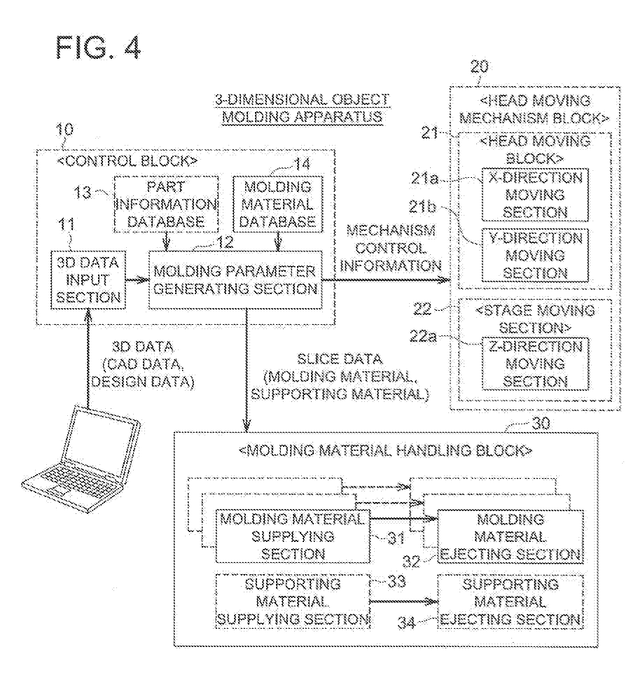

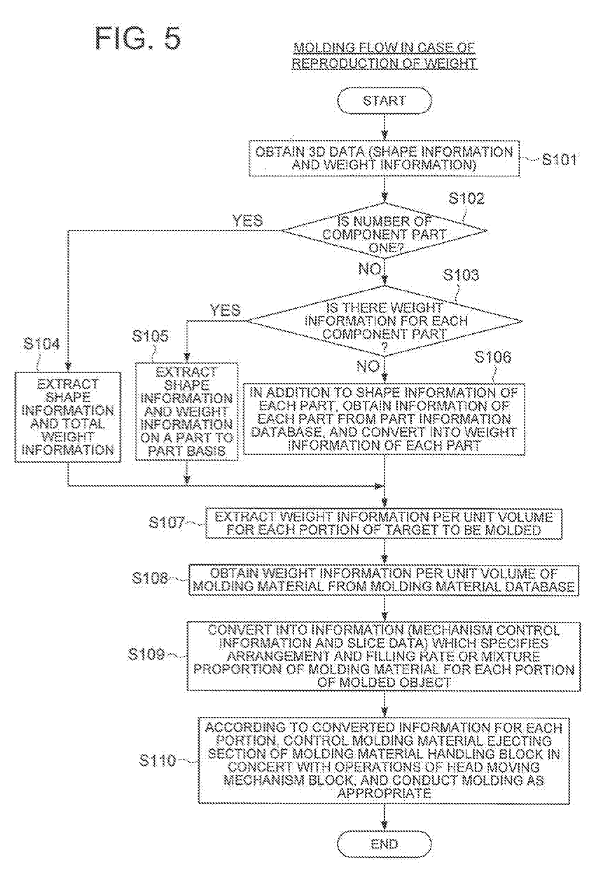

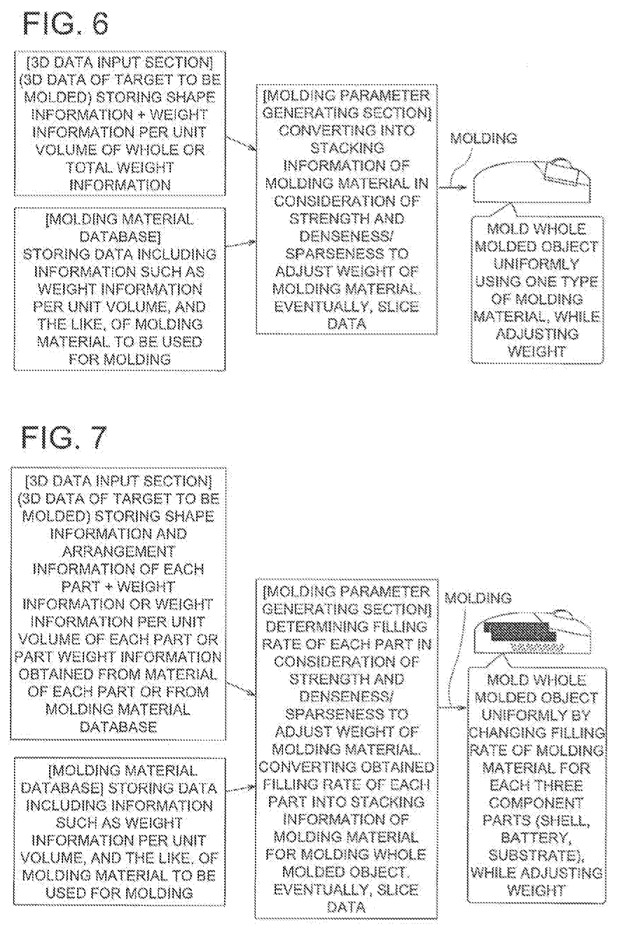

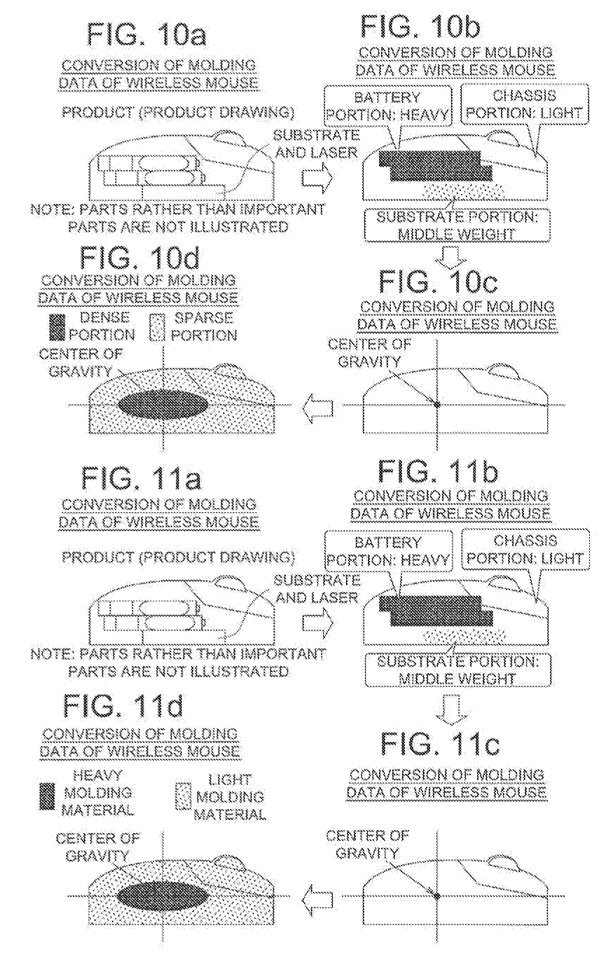

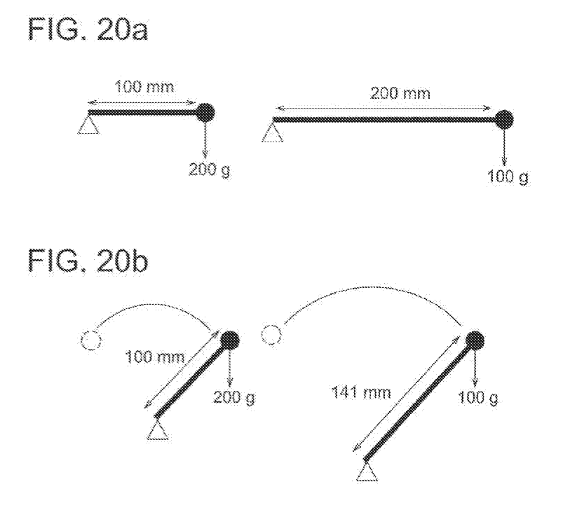

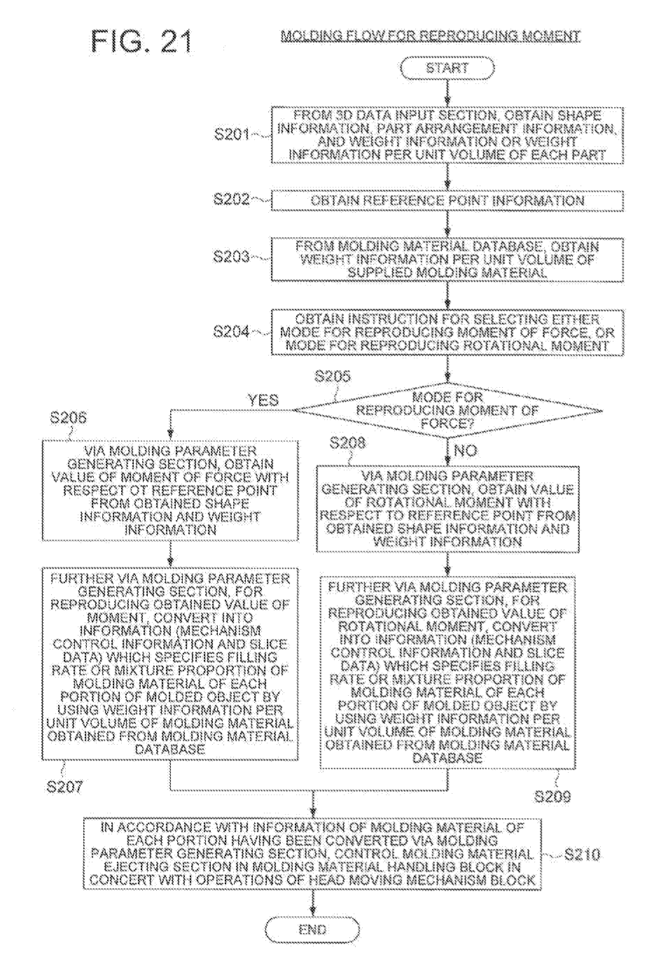

To describe the further details of the aforementioned preferred embodiment of the present invention, the following describes a three-dimensional object molding apparatus and a control program according to one example of the present invention with reference to FIGS. 1a, 1b, 1c, 1d, and 1e through 21. FIGS. 1a, 1b, 1c, 1d, and 1e are explanatory diagrams illustrating variations of methods, by classification, for reproducing a weight of a molded object. FIGS. 2a, 2b, and 2c each is a diagram illustrating an example of a structure for reproducing the weight by a degree of denseness/sparseness of a molding material, and FIGS. 3a and 3b are diagrams schematically illustrating examples of structures of heads in a case in which the weight is reproduced by using a plurality of molding materials. FIG. 4 is a block diagram illustrating a structure of a three-dimensional object molding apparatus according to a preferred embodiment of the present invention, and FIG. 5 is a flow chart explaining steps for molding of a three-dimensional object according to a preferred embodiment of the present invention. FIGS. 6 through 9, and FIGS. 12 through 18 each is a diagram illustrating a method for reproducing a weight of a molded object. FIGS. 10a, 10b, 10c, and 10d, and FIGS. 11a, 11b, 11c, 11d, and 11e each is a diagram illustrating a method for reproducing a position of the center of gravity of a molded object. FIG. 19 and FIGS. 20a and 20b each is a diagram schematically illustrating a method for reproducing a moment of a molded object. FIG. 21 is a flow chart explaining steps for molding of a three-dimensional object (in a case of reproducing the moment) according to a preferred embodiment of the present invention.

It is to be noted that, in the description of examples below, a goods being object for molding refers to as a target to be molded, a goods produced via a three-dimensional object molding apparatus by simulating a target to be molded refers to as a molded object. Also, a material to be used for manufacturing a molded object refers to as a molding material.

Further, the filling rate refers to as a ratio of volume of a molding material per unit spatial volume, and represents a degree of denseness/sparseness of the molding material. In a case in which the filling rate is less than 100%, the portion occupied by rather than the molding material in the space corresponds to gas such as air, liquid such as water, vacuum, or the like. Further, the mixture proportion refers to as a proportion of the ratio (filling rate) of volume of an individual molding material per unit spatial volume (hereinafter “per unit spatial volume” is referred simply to as “per unit volume”), which is synonymous with a proportion of the filling rates. For example, in a case in which the filling rate of material A for molding=20%, the filling rate of material B for molding=30%, and the filling rate of material C for molding=50%, the mixture proportion of A, B, and C is 2:3:5, and the filling rate of A, B, and C in total is 100%. Also, in a case in which the filling rate of material A for molding=20%, the filling rate of material B for molding=20%, and the filling rate of material C for molding=50%, the mixture proportion of A, B, and C is 2:2:5, and the filling rate of A, B, and C in total is 90%.

In a case in which a molded object is produced based on a target to be molded, in the present example, the weight of the target to be molded is reproduced by entirely or partially adjusting the filling rate (the degree of denseness/sparseness) or the mixture proportion of the molding material, but it is not limited to the example, and a variety of methods for reproducing the weight may be considered. These examples will be described more specifically with reference to FIGS. 1a, 1b, 1 c, 1d, and 1e below.

[A Method in which One Type of Molding Material is Used and the Weight of a Molded Object Per Unit Volume is the Same in the Entire Area the Molded Object (Refer to FIG. 1a)]

In the case of this method, shape information and weight information of a molded object are generated from shape information and weight information (total weight information, or weight information per unit volume, or weight information obtained by adding weight or weight per unit volume of each part that constitutes the molded object) of the target to be molded, included in three-dimensional data (CAD (Computer Aided Design) data, design data, and the like, and hereinafter referred to as 3D data) of the target to be molded, and based on weight information of a molding material which has been supplied in the apparatus, and the shape information and the weight information, having been generated, a filling rate of the molding material is obtained, and according to the filling rate having been obtained, a molded object is produced. To adjust the filling rate, for example, a molding material may be stacked so as to become a honeycomb structure, a sponge structure, or a corrugated structure as illustrated in FIGS. 2a, 2b, and 2c, respectively, so as to form hollows uniformly throughout the molded object. Also, by elaborating the shape of a head for ejecting the molding material so as to suck in air, hollows may be formed at a constant rate.

[A Method in which One Type of Molding Material is Used and the Weight of a Molded Object Per Unit Volume is Partially Changed (Refer to FIG. 1b)]

In the case of this method, shape information and weight information of a molded object are generated from shape information of each part and weight information per unit volume included in 3D data of the target to be molded, and based on weight information per unit volume of a molding material which has been supplied in the apparatus, and the shape information and the weight information, having been generated, a filling rate of the molding material for each portion is obtained, and according to the filling rate having been obtained for each portion, the entirety of a molded object is produced by molding each portion in accordance with the filling rate having been obtained for each portion. To adjust the filling rate, for example, the size of hollows in the honeycomb structure, sponge structure, or corrugated structure, illustrated in FIGS. 2a, 2b, and 2c, respectively, may be partially changed. Also, similarly to the above, by elaborating the shape of a head for ejecting a molding material so as to suck in air, and further, by making the amount of air to be sucked in adjustable, hollows may be formed at a ratio according to the portion.

[A Method in which a Plurality of Types of Molding Materials is Mixed Evenly to Each Other, and the Weight of a Molded Object Per Unit Volume is the Same in the Entire Area the Molded Object (Refer to FIG. 1c)]

In the case of this method, shape information and weight information of a molded object are generated from shape information and weight information (total weight information, or weight information per unit volume, or weight information obtained by adding weight or weight per unit volume of each part that constitutes the molded object) of the target to be molded, included in 3D data of the target to be molded, and based on weight information per unit volume of a plurality of molding materials which has been supplied in the apparatus, and the shape information and the weight information, having been generated, a mixture proportion of the plurality of the molding materials is determined, and a molded object is produced by stacking the mixed molding materials according to the mixture proportion having been determined. It is to be noted that the filling rate of the molded object may be 100%, or may be less that 100%. To make the filling rate to be 100%, as illustrated in FIG. 3a, a plurality of molding materials may be mixed in a head and ejected (refer to the figure in the left), or, by disposing a mixing unit, which mixes the plurality of molding materials, in a preceding stage of the head, the mixed molding materials, having been mixed via the mixing unit, may be ejected from the head (refer to the figure in the right). Further, in a case in which the filling rate is set to be less than 100%, by using the mixed molding materials, a molded object may be molded so as to form hollows uniformly in the entire area of the molded object. Further, by elaborating the shape of the head for ejecting the molding material so as to suck in air, hollows may be formed at a constant rate.

[A Method in which a Plurality of Types of Molding Materials is Used, and the Weight of a Molded Object Per Unit Volume is Partially Changed (Refer to FIGS. 1d and 1e)]

In the case of this method, shape information and weight distribution information of the molded object are generated from shape information of each part and weight information per unit volume included in 3D data of the target to be molded, and based on weight information per unit volume of a plurality of molding materials which has been supplied in the apparatus, and the shape information and the weight distribution information, having been generated, a mixture proportion of the plurality of the molding materials for each portion is determined, and a molded object is produced by stacking the molding materials having been mixed according to the determined mixture proportion. For example, in a case in which a molding material is ejected from a head, as illustrated in FIG. 3a, the mixture proportion of the plurality of the molding materials may be adjusted in the head according to the portion (refer to the figure in the left), or, by disposing a mixing unit, which mixes the plurality of the molding materials, in a preceding stage of the head, the molding materials, having been mixed via the mixing unit, may be ejected from the head (refer to the figure in the right). Further, as illustrated in FIG. 3b, by injecting each individual molding material into separate heads, a desired molding material may be ejected by switching the head for each individual portion (refer to the figure in the left), or by disposing a material selector, which switches the plurality of the molding materials, in a preceding stage of the head, the molding materials, having been selected via the material selector in accordance with the portion, may be ejected from the head (refer to the figure in the right).

Next, an apparatus which produces a molded object by using the techniques illustrated in FIGS. 1a through 1e will be described. FIG. 4 is a block diagram illustrating a structure of a three-dimensional object molding apparatus according to the present example. This three-dimensional object molding apparatus is an apparatus for molding a three-dimensional object by employing a method such as a fused deposition molding (FDM) method, an inkjet method, or the like, and is composed of three blocks, a control block 10, a head moving mechanism block 20, and a molding material handling block 30. Each of the blocks illustrated in FIG. 4 will be described below.

### [Control Block]

The control block 10 is composed of a 3D data input section 11, a molding parameter generating section 12, a part information database 13, a molding material database 14, and the like.

The 3D data input section 11 obtains 3D data (CAD data, design data, or the like), which is necessary for producing a desired molded object and includes three-dimensional shape information of a target to be molded, from a computer device or the like, and transfers the 3D data to the molding parameter generating section 12. It is to be noted that a method to obtain 3D data is not limited to a specific method, and 3D data may be obtained by employing a wired communication, a wireless communication, a short distance wireless communication such as a Bluetooth (Registered Trade Mark) or the like, or may be obtained by employing a recording medium such as a USB (Universal Serial Bus) memory or the like. Further, this 3D data may be directly obtained from a computer which designs a target to be molded, or may be obtained from a server, which manages and stores 3D data, or the like.

The molding parameter generating section 12 extracts shape information and weight information of the target to be molded by analyzing the 3D data; calculates a filling rate and a mixture proportion for reproducing the shape and the weight of a molded object based on the extracted shape information and weight information of the target to be molded, and the weight information of molding materials having been stored in the molding material database 14; and converts into molding information for stacking the molding materials at the filling rates and the mixture proportions, having been calculated. Then, the molding parameter generating section 12 transmits mechanism control information, which is used for ejecting a molding material to a desired position, to the head moving mechanism block 20, and also transmits a slice data which specifies a molding material on a layer to layer basis, to the molding material handling block 30.

The aforementioned 3D input section 11 and the molding parameter generating section 12 may be constituted as a hardware, or may be constituted as a control program which functions as the 3D input section 11 and the molding parameter generating section 12, and such control program may be made to be operated in a three-dimensional object molding apparatus, or in an apparatus which controls such three-dimensional object molding apparatus.

The part information database 13 stores information (information such as a position, a shape, a material, or the like, of each part) with respect to each part which constitutes a target to be molded, and provides the molding parameter generating section 12 with the stored information.

The molding material database 14 stores information (information such as weight per unit volume) with respect to molding materials having been supplied in the three-dimensional object molding apparatus, and provides the molding parameter generating section 12 with the stored information.

### [Head Moving Mechanism Block]

The head moving mechanism block 20 is composed of a head moving block 21 and a stage moving block 22. The head moving block 21 is composed of an x-direction moving section 21a, a y-direction moving section 21b, and the like, and the stage moving block 22 is composed of a z-direction moving section 22a, and the like.

The head moving block 21 (x-direction moving section 21a and y-direction moving section 21b) drives a motor or a driving mechanism (not illustrated in the figure), and manipulates a head, which is for ejecting a molding material, to move in an x direction (lateral direction) or in a y direction (lateral direction).

The stage moving block 22 (z-direction moving section 22a) drives a motor or a driving mechanism (not illustrated in the figure), and adjusts a distance between a head and a molded object by moving a molding stage in a z direction (downward), or moving the head moving block 21 in a z direction (upward).

### [Molding Material Handling Block]

The molding material handling block 30 is composed of a molding material supplying section 31, a molding material ejecting section 32, a supporting material supplying section 33, a supporting material ejecting section 34, and the like.

The molding material supplying section 31 provides a head with a selected or mixed material by selecting a molding material in accordance with the slice data, having been obtained from the control block 10, or mixing a plurality of molding materials. Also, the molding material ejecting section 32 stacks the molding material at a desired filling rate by ejecting the molding material in accordance with the slice data having been obtained from the control block 10. It is to be noted that each one of, or each plurality of the molding material supplying sections 31 and the molding material ejecting sections 32 may be installed in the three-dimensional object molding apparatus.

The supporting material supplying section 33 provides a head with a supporting material, which is removed via water, heat, or a release agent after completion of a molding, in accordance with the slice data having been obtained from the control block 10. Also, the supporting material ejecting section 34 stacks supporting materials by ejecting the supporting materials on the molding stage. This supporting material plays a role of a kind of pillar which supports molding materials in the upper layers in cases in which an overhung portion is molded when molding upward. Therefore, in cases in which a molded object, having no overhung portion, is to be produced, the supporting material supplying section 33 and the supporting material ejecting section 34 may be omitted.

Next, steps for producing a molded object, in which the shape and weight of a target to be molded are reproduced, by using the aforementioned three-dimensional object molding apparatus, will be described with reference to the flow chart illustrated in FIG. 5.

First, by using a computer device, 3D data, such as CAD data, design data, or the like, of a target to be molded, is generated. In those CAD data and design data, not only the shape information of a molded object as a matter of course, but also the weight information of each portion of the molded object, or the weight information and the material information of each part, which constitutes the molded object, are included.

The 3D data, generated at the computer device, is taken by the control block 10 (3D data input section 11) of the three-dimensional object molding apparatus, and is transmitted to the molding parameter generating section 12 (step S101).

In the molding parameter generating section 12, by analyzing the 3D data, it is determined whether or not the number of part which constitutes the molding materials is one (step S102). In cases in which the weight of the molded object per unit volume is uniform throughout the molded object (in other words, in cases in which the molded object is composed of one part), the shape information and the total weight information of the 3D data is extracted (step S104).

On the other hand, in cases in which the weight of the molded object per unit volume differs on a portion to portion basis, or on a part to part basis (in other words, in cases in which the molded object is composed of a plurality of parts), it is determined whether or not the weight information of each part is specified in the 3D data (step S103), and if the weight information has been specified in the 3D data, the shape information and the weight information is extracted on a part to part basis (step S105).

In cases in which the weight information of each part has not been specified in the 3D data, the shape information is extracted from the 3D data, and information with respect to each part is obtained from the part information database 13, and the information, having been extracted and obtained, are converted into the weight information of each part (step S106). It is to be noted that, in the case of a specific object such as a battery, the weight information may be obtained directly, and in the case of a material such as a plastic, an iron, or the like, the weight information may be obtained from the weight per unit volume and the part volume obtained from the shape.

In this way, when the weight information in total or for each part has been determined (step S107), the molding parameter generating section 12 obtains weight information per unit volume of molding materials to be used from the molding material database 14 (step S108).

Then, the molding parameter generating section 12 converts the shape information and weight information of the target to be molded, and the weight information of the molding materials per unit volume, into molding information (mechanism control information for the head moving mechanism block 20, and slice data for the molding material handling block 30) which specifies that a molding material of what filling rate or mixture proportion is to be ejected to what position (arrangement information of part) so as to reproduce the shape and weight of the target to be molded (step S109).

When the conversion is complete, the process proceeds to actual molding operations. More specifically, the molding parameter generating section 12 transmits the mechanism control information to the head moving mechanism block 20, and transmits the slice data to the molding material handling block 30. Then, the head moving mechanism block 20 moves a position of the head, which ejects molding materials, in a three-dimensional manner in accordance with the mechanism control information, and at the same time, the molding material handling block 30 ejects and stacks the molding materials in accordance with the slice data (step S110).

For example, in the head moving mechanism block 20, the head for ejecting a molding material is manipulated to move in an x-direction (lateral direction), in a y-direction (lateral direction), or in a z-direction (height direction). Also, in the molding material handling block 30, the molding material supplying section 31 provides the molding material ejecting section 32 with the molding material, and the supporting material supplying section 33 provides the supporting material ejecting section 34 with the supporting material. Whereby, the molding material and supporting material are stacked in series, and a molded object is complete (step S110).

By conducting the aforementioned control, it is possible not only to mold a molded object having an identical shape as that of the target to be molded, but also to mold a molded object having an identical weight as that of the target to be molded, thus, it is possible to mold a molded object which is closer to the actual object.

Heretofore, a basic action, in the case of producing a molded object in which the shape and weight have been reproduced, has been explained. A more specific control will be described below by using a case, as an example, in which a wireless mouse as a target to be molded is produced.

First, as illustrated in FIG. 6, the case, in which a molded object is molded uniformly throughout the molded object by using one type of molding material, will be described. For example, the weight per unit volume of a molded object, which has been obtained from the 3D data input section 11, is assumed to be 3 g/cm³, the weight per unit volume of the molding material to be used in the three-dimensional object molding apparatus is assumed to be 4 g/cm³, then the filling rate becomes ¾=0.75=75%, and therefore, the molded object is molded by stacking the molding material with a filling rate of 75%. In this case, the molded object is to be molded in such a manner that the molding material is made continuous, in order to portray the exterior appearance of the molded object after molding, and also to ensure the strength as a structure. Further, in cases in which the filling rate is less than 100%, the remaining portion (in this example, it is a portion of 25%) is produced as a space.

Also, in cases in which 3D data which can be obtained from the 3D input section 11 are shape information and total weight information, the volume (area) of the three-dimensional object is obtained from the shape information, then, the weight per unit volume can be obtained by diving the total weight by the obtained volume, and therefore, it is possible to obtain the filling rate in such a way described above. For example, in a case in which the volume is 100 g/cm³ and the total weight is 300 g, the weight per unit volume becomes 300/100=3 g/cm³, and therefore, similarly to the above, the filling rate becomes ¾=0.75=75%.

Next, as illustrated in FIG. 7, the case, in which one type of molding material is used and a molded object is molded uniformly throughout the molded object by changing the filling rate (degree denseness/sparseness) of the molding material on a part to part basis, will be described. For example, in a case in which a wireless mouse is composed of three parts, a chassis (shell), a battery, and a substrate on which optical components are mounted, shape information, arrangement information, and weight information of each of the chassis, the battery, and the substrate are obtained from the 3D data, having been obtained from the 3D data input section 11.

For example, if the volume and the weight of each of the parts are assumed to be as follows:
Chassis: material volume=100 cm³, weight=100 g,
Battery: material volume=25 cm³, weight=100 g,
Substrate: material volume=25 cm³, weight=50 g, then the weight per unit volume of each of the parts is calculated as follows:
Chassis: 100/100=1 g/cm³,
Battery: 100/25=4 g/cm³,
Substrate: 50/25=2 g/cm³.

Here, in a case in which the weight per unit volume of the material used in the three-dimensional object molding apparatus is assumed to be 4 g/cm³, then the filling rate of each of the parts is calculated as follows:
Chassis: ¼=0.25=25%,
Battery: 4/4=1.00=100%,
Substrate: 2/4=0.50=50%.

As a result of the above calculations, the weight of the wireless mouse can be reproduced by molding the chassis portion with a filling rate of 25%, the battery portion with a filling rate of 100%, and the substrate portion with a filling rate of 50%. In this case, similarly to the above, the molded object is to be molded in such a manner that the molding material is made continuous, in order to portray the exterior appearance of the molded object after molding, and also to ensure the strength as a structure. Further, in cases in which the filling rate is less than 100%, the remaining portion (in this example, 75% of the chassis portion and 50% of the substrate portion) is produced as a space. It is to be noted that, in a case in which weight information per unit volume of each part is obtained directly from the 3D data, the calculation to convert into weight information per unit volume is unnecessary.

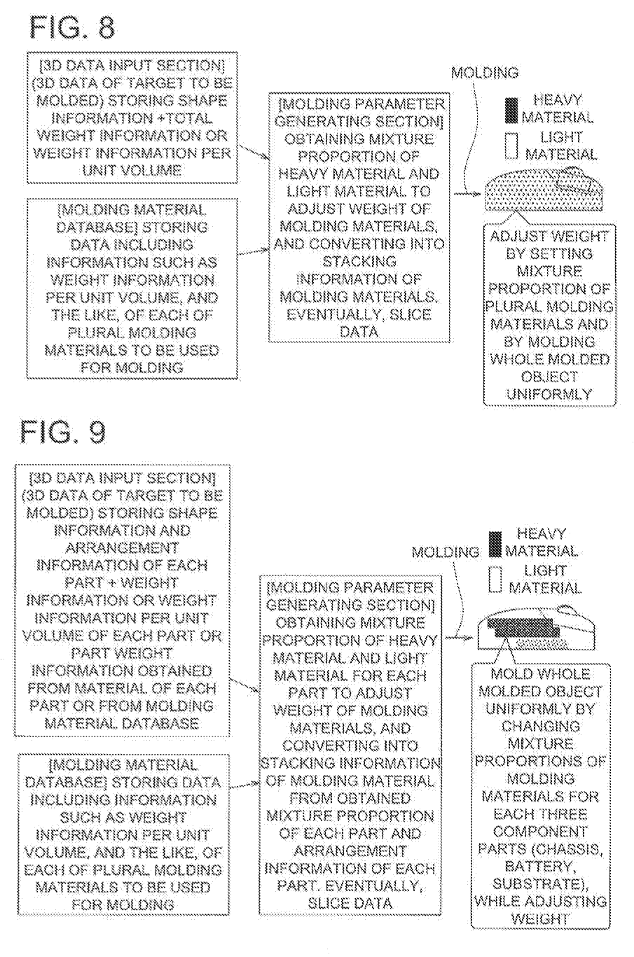

Next, as illustrated in FIG. 8, a case will be described in which a plurality of molding materials (two types in this case) is used and a molded object is molded uniformly throughout the molded object by changing the mixture proportions of the plurality of the molding materials. For example, the weight per unit volume of a molding material A is assumed to be “a” (g/cm³), the weight per unit volume of a molding material B is assumed to be “b” (g/cm³), the weight per unit volume of a molded object, having been completed, is assumed to be “m” (g/cm³), then, mixture proportion S of the molding material A and the molding material B can be obtained by solving an equation “a”×S+“b”×(1−S)=“m”.

More specifically, in a case in which the weight per unit volume of the completed molded object obtained from the 3D data input section 11 is 3 g/cm³, and there are two types of the weights per unit volume, 6 g/cm³ and 2 g/cm³, of the molding materials to be used in the three-dimensional object molding apparatus, then, by solving an equation 6×S+2×(1−S)=3, S=¼=0.25 is obtained. Therefore, the mixture proportion of the molding material A and the molding material B becomes 1:3.

Next, as illustrated in FIG. 9, a case will be described in which a plurality of molding materials (two types in this case) is used and a molded object is molded uniformly throughout the molded object by changing the molding materials on a part to part basis. For example, in a case in which a wireless mouse is composed of three parts, a chassis (shell), a battery, and a substrate on which optical components are mounted, shape information and weight information of each of the chassis, the battery, and the substrate are obtained from the 3D data, having been obtained from the 3D data input section 11.

For example, if the volume and the weight of each of the parts are assumed to be as follows:
Chassis: material volume=100 cm³, weight=100 g,
Battery: material volume=25 cm³, weight=100 g,
Substrate: material volume=25 cm³, weight=50 g, then the weight per unit volume of each of the parts is calculated as follows:
Chassis: 100/100=1 g/cm³,
Battery: 100/25=4 g/cm³,
Substrate: 50/25=2 g/cm³.

Here, the weight per unit volume of a molding material A is assumed to be “a” (g/cm³), the weight per unit volume of a molding material B is assumed to be “b” (g/cm³), the weight per unit volume of a molded object, having been completed, is assumed to be “m” (g/cm³), then, mixture proportion S (chassis), mixture proportion S (battery), and mixture proportion S (substrate) of the molding material A and the molding material B can be obtained by solving an equation “a”×S+“b”×(1−S)=“m”.

More specifically, in a case in which there are two types of the weights per unit volume, 4 g/cm³ (molding material A) and 1 g/cm³ (molding material B), of the molding materials to be used in the three-dimensional object molding apparatus, then, the mixture proportion of the chassis (1 g/cm³) is obtained from 4×S+1×(1−S)=1, then S=0.0, and therefore, the ratio of the molding material A=0%, and the ratio of the molding material B=100%. The mixture proportion of the battery (4 g/cm³) is obtained from 4×S+1×(1−S)=4, then S=1.0, and therefore, the ratio of the molding material A=100%, and the ratio of the molding material B=0%. The mixture portion of the substrate (2 g/cm³) is obtained from 4×S+1×(1−S)=2, then S=0.33, and therefore, the ratio of the molding material A=33.3%, and the ratio of the molding material B=66.7%. Thus, the molding material A and the molding material B may be mixed at the above-mentioned ratio for each portion of the chassis, battery, and the substrate.

Also, in a case in which the weight per unit volume of the aforementioned chassis is 0.5 g/cm³, it is necessary to mold a molded object lighter than the molding material B which is lighter than the molding material A. Therefore, the molding material B (1 g/cm³) only is used for the chassis portion, and by molding at a filling rate of 50%, it is possible to realize 0.5 g/cm³. In this case, although the remaining portions, in which the molding material is not filled, are made as an empty space, it is preferable to mold in such a manner that the molding material is made continuous. Further, in a case in which the weight information per unit volume of each part can be obtained directly from the 3D data input section 11, the calculation to convert into weight information per unit volume is unnecessary.

Although methods to reproduce weight which is the same as that of a target to be molded have been described above, even if the weight is the same, massive feeling, when the molded object is held in one's hands, may differ if the molded object has a different position of the center of gravity. Therefore, in order to produce a molded object closer to the target to be molded, the position of the center of gravity, which is the same as that of the target to be molded, can be reproduced by changing a filling rate of a molding material, or by changing mixture proportions of a plurality of molding materials.

For example, in a case in which one type of molding material is used, as illustrated in FIGS. 10a, 10b, 10c, and 10d, similarly to the above, weight information of each part (chassis, first battery, second battery, substrate), which constitutes a molded object, is obtained from 3D data obtained from the 3D data input section 11, the position of the center of gravity of the entirety of a target to be molded is obtained based on central coordinates of each part and the weights of the parts, by using a known technique. Then, while reproducing the weight of the target to be molded, the position of the center of gravity of the target to be molded is also reproduced by increasing the filling rate (higher denseness) of the molding material near the position of the center of gravity, and by decreasing the filling rate (lower denseness) of the material in the other area.

Further, in a case in which a plurality of types of molding materials is used, as illustrated in FIGS. 11a, 11b, 11c, and 11d, weight information of each part (chassis, first battery, second battery, substrate), which constitutes a molded object, is obtained from 3D data obtained from the 3D data input section 11, the position of the center of gravity of the entirety of a target to be molded is obtained based on central coordinates of each part and the weights of the parts, by using a known technique. Then, while reproducing the weight of the target to be molded, the position of the center of gravity of the target to be molded is also reproduced by using a molding material, which is heavy in weight per unit volume, near the position of the center of gravity, and by using a molding material, which is light in weight per unit volume, in the other areas.

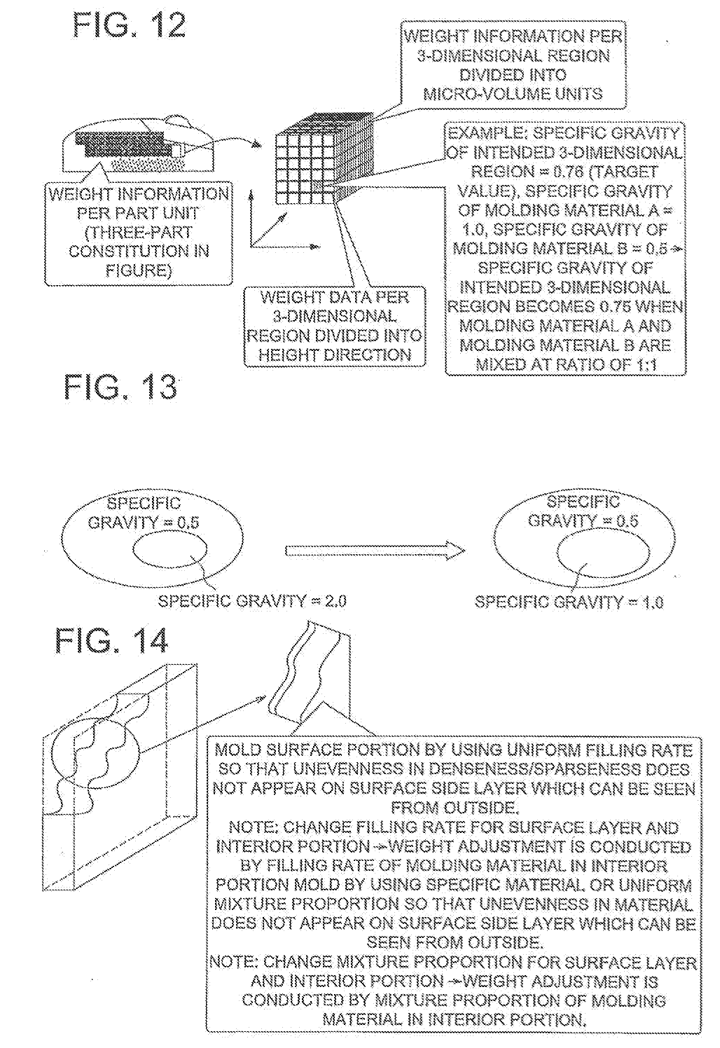

Although a molded object is molded by changing the filling rates (denseness/sparseness) or the mixture proportions of the parts in the case in which a plurality of parts constitutes the target to be molded, as described above, such a structure is not essential. For example, the target to be molded may be divided into micro-volume units in a case in which the weight of the target to be molded is to be reproduced more minutely, as illustrated in FIG. 12.

For example, the entirety of a target to be molded may be divided into micro-cubes or into physical micro-three-dimensional bodies in x, y, z directions (in vertical, horizontal and height directions) based on part information of each portion which constitutes the shape of the entirety of the target to be molded obtained from the 3D data input section 11, and weight information is generated with respect to the entirety of each individual three-dimensional region, having been divided, and based on the obtained weight information of each individual three-dimensional region, the weight may be reproduced per unit of a micro region.

It is to be noted that there may be a case in which the weight cannot be reproduced faithfully in the entire region in a case there is a part of the target to be molded, which is heavier in weight per unit volume than that of the heaviest molding material having been supplied in the three-dimensional object molding apparatus, in the weight information of the target to be molded having been obtained from 3D data input section 11. In other words, it is difficult to reproduce the weight of the portion which is heavier than the heaviest molding material. However, as long as the entirety of the target to be molded is not heavier than the molding material, the total weight or the position of the center of gravity of the target to be molded may match those of the molded object by changing weight distribution in interior regions.

For example, in a case of an egg-shaped molded object as illustrated in FIG. 13, in cases in which a region of a specific gravity of 2.0 exists in a core portion in the original 3D data, and a specific gravity of a heaviest molding material is 1.0, the weight of entire molded object may be adjusted by increasing the volume of the core portion, while maintaining the position of the center of gravity.

Next, a method, in which a texture of a target to be molded is reproduced, will be described. A molded object, which is produced by a three-dimensional object molding apparatus, is often used as a mock-up to evaluate the exterior appearance. When an evaluator holds a molded object produced by a three-dimensional object molding apparatus in his/her hands and takes a look at the molded object, the evaluator may not be able to see the inside, but the evaluator may gaze surface portions and may evaluate the touch feeling of the molded object when the evaluator holds and touches it. In other words, it is required to provide a molded object which has a same texture even when the molded object is viewed from any angle, or wherever it is touched.

Meanwhile, in a case in which a weight adjustment is carried out by changing the filling rate (denseness/sparseness) of a molding material, if molding parameters are adjusted in all regions of the surface and the interior of a molded object, a problem to be described below may arise.

For example, in a case in which the filling rate (denseness/sparseness) is changed with respect to each portion on the surface of a molded object, although dense portions may become smooth without irregularities (without concavity and convexity), sparse portions may become spongy with sponge-like appearance more than a little, and therefore, both appearance and touch may have irregularities. Also, although dense portions tend to have more portions in which the molding material is made continuous, and the strength is enhanced, sparse portions tend to have less portions in which the molding material is made continuous, which results in a lowering of strength of joint regions, and therefore, a problem may arise in which the molded object tends to be weak in strength.

Also, in a case in which the mixture proportion is changed with respect to each portion on the surface of a molded object, the texture and color of the molded object may differ depending on a difference in the mixture proportion with respect to each portion. For example, in a case in which a black rubber material and a white resin material is mixed, the portions having a higher ratio of the black rubber material tend to be molded softly with a darker color, while the portions having a higher ratio of the white resin material tend to have a hard texture with a lighter color.

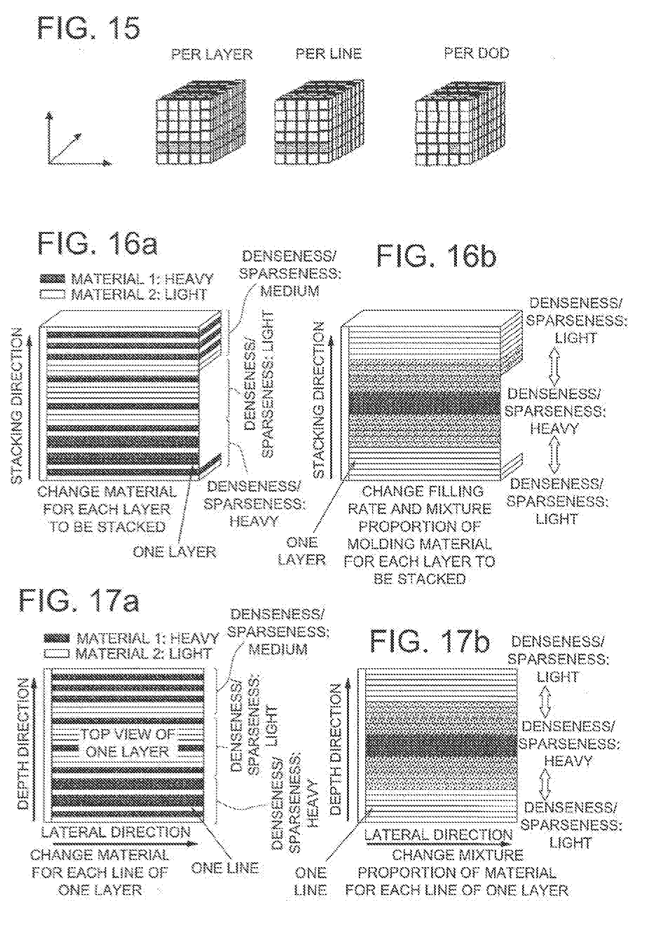

To solve the above mentioned problems and to reproduce a molded object with the same texture even when the molded object is viewed from any angle or wherever it is touched, as illustrated in FIG. 14, in a case in which one type of molding material is used, the surface portion of the molded object is molded with a filling rate (denseness/sparseness) and a mixture proportion which are different from these for the interior portion. Also, by making the filling rate of a molding material for the surface portion to a higher filling rate (including 100%), connections among molding materials of surface portion are increased, which results in an enhancement of strength. In other words, spaces for forming denseness/sparseness are formed in the interior portion, which is not visible, so as to reproduce a uniform weight, molding strength, and texture as the entirety of the molded object.

In this case, although the weight per unit volume differs depending on the surface portion or the interior portion, in many cases, the influence relating to a total weight can be ignored because the volume of the surface portion is considered to be small compared to that of the interior portion, and also, in a case in which more than one type of molding material are used, the texture of the surface portion may be arranged by molding the surface portion, as an exception, with a predetermined mixture proportion which differs from that for the interior portion.

Next, methods to change the filling rate (denseness/sparseness) or the mixture proportion on a portion to portion basis will be described. When stacking a molding material ejected from a molding head, as illustrated in FIG. 15, a method in which stacking of the molding material is controlled for each layer, a method in which stacking of the molding material is controlled for each line, and a method in which stacking of the molding material is controlled for each dot, are considered. Each of the methods will be described below by comparing the advantages of the methods.

As illustrated in FIG. 16a, in a case of the method in which a molded object is molded by changing the molding material to be used for each layer to be stacked, or, as illustrated in FIG. 16b, in a case of the method in which a molded object is molded by changing the filling rates of one type of molding material, or changing the mixture proportions of a plurality of molding materials, for each layer to be stacked, with respect to the change for each layer, the speed of the change is not an essential when compared to the change for each line or for each dot, and therefore, the method has an advantage that it is possible to achieve the changing operation via a low-performance mechanism.

Further, as illustrated in FIG. 17a, in a case of the method in which a molded object is molded by changing the molding material, to be used, for each line to be stacked, or, as illustrated in FIG. 17b, in a case of the method in which a molded object is molded by changing the filling rates of one type of molding material, or changing the mixture proportions of a plurality of molding materials, for each line to be stacked, with respect to the change for each line, although the change is required to be carried out at high-speed when compared to the change for each layer, the method has an advantage that it is possible to control the weight of the molded object minutely. It is to be noted that, in a molding method such as a thermal fusion method in which a molding head moves in a traversable manner, changing per each unit of constant length may substitute for the change for each line.

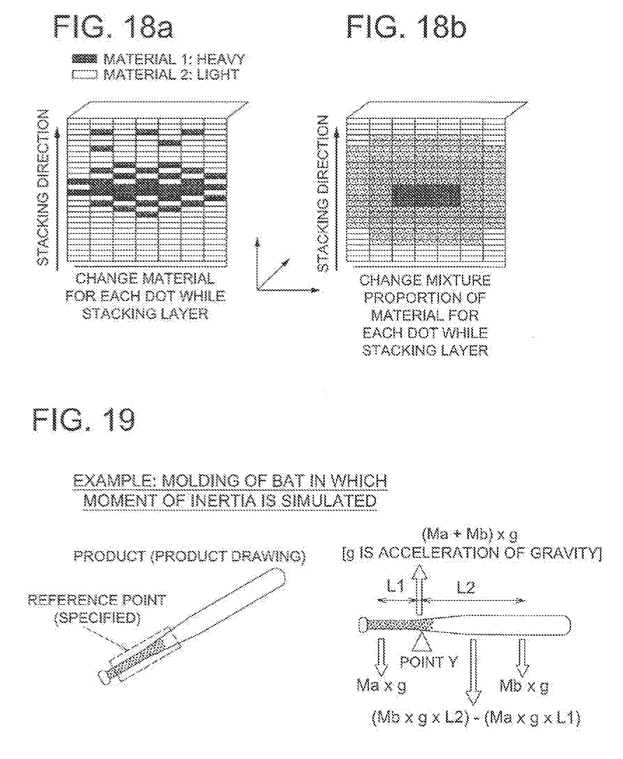

Further, as illustrated in FIG. 18a, in a case of the method in which a molded object is molded by changing the molding material, to be used, for each dot to be stacked, or, as illustrated in FIG. 18b, in a case of the method in which a molded object is molded by changing the filling rates of one type of molding material, or changing the mixture proportions of a plurality of molding materials, for each dot to be stacked, with respect to the change for each dot, although the change is required to be carried out at high-speed when compared to the change for each layer or for each line, the method has an advantage that it is possible to control the weight of the molded object most minutely.

As described above, as each method has an advantage, it can be determined that which method is to be employed to produce a molded object in consideration of the performance of a three-dimensional object molding apparatus and/or the reproducibility which is required for the molded object. Also, in a case in which a three-dimensional object molding apparatus, which can employ any of the methods, is used, it may be possible to switch the methods in such a manner that the change for each line is employed for the portions having less changes in the filling rates (denseness/sparseness) and the mixture proportions, the change for each line is employed for the portions having moderate changes in the filling rates (denseness/sparseness) and the mixture proportions, and the change for each line is employed for the portions having more changes in the filling rates (denseness/sparseness) and the mixture proportions

Although the cases have been described above, in which the weight, the position of the center of gravity, the texture, and the like, of a target to be molded are reproduced, even if the weight and the position of the center of gravity of a molded object are the same as those of the target to be molded, massive feeling of the molded object may differ when the moment is different. Therefore, in order to produce a molded object closer to the target to be molded, the moment, which is the same as that of the target to be molded, may be reproduced by changing the filling rates (denseness/sparseness) of a molding material, or by changing the mixture proportions of a plurality of molding materials.

By using a bat as illustrated in FIG. 19, as an example, a method will be described in which a rigid-body moment is reproduced. From the 3D data input section 11, shape information and weight information of the bat is obtained, and also, the position of a reference point Y, having been designated in advance, is obtained. At that time, a resultant force of a load on a grip side and a load at a top side is applied on the reference point Y on the bat. Therefore, by first dividing the bat at the reference point Y into the right and left sides, the load at each side is obtained.

As illustrated in FIG. 19, a load, which is obtained by multiplying the force of gravity (Ma×g), applied on the center of gravity of the grip side, by a distance L1 from the reference point Y to the center of gravity, is applied as a load at the grip side from the reference point Y. Also, as a load at the top side from the reference point Y, a load, which is obtained by multiplying the force of gravity (Mb×g), applied on the center of gravity of the top side, by a distance L2 from the reference point Y to the center of gravity, is applied. Therefore, a load applied on the reference point Y is a resultant force of a force of ((Ma+Mb)×g) applied in a direction opposite to the direction of gravitational force, and a rotational force of ((Mb×g×L2)−(Max g×L1)) derived from the difference between the loads at the top side and the grip side.

Therefore, in this example, by adjusting the filling rates (denseness/sparseness) of a molding material and the mixture proportions of a plurality of molding materials, the total weight is set to (Ma+Mb), and a molded object is molded by the adjusting distribution of the molding materials so that a force applied on the reference point Y becomes to be ((Mb×g×L2)−(Ma×g×L1)).

At that time, the shape information and the weight information, obtained from the 3D data input section 11, may be faithfully reproduced, however, it is unnecessary to reproduce those faithfully in a case in which the shape, total weight, and moment are only reproduced. As a matter of course, although the total weight cannot be changed because it becomes an absolute value, the moment applied on the reference point may be adjusted to a desired value even though an arrangement of the molding materials may vary. For example, as illustrated in FIG. 20a, in a case in which a load of 200 g is applied on a position which is 100 mm away from a reference point, and in a case in which a load of 100 g is applied on a position which is 200 mm away from the reference point, action of force applied on the reference position may be the same in both cases, and therefore, a molded object may be molded in either weight distribution.

Also, the shape information and the weight information can be reproduced by a rotational moment, not by a moment of force. In general, a rotational moment is calculated by using the weight and the radius squared, for example, as illustrated in FIG. 20b, in a case in which a load of 200 g is applied on a position which is 100 mm away from a reference point and the load is rotated around the reference point serving as the rotation center, and in a case in which a load of 100 g is applied on a position which is 141 mm (more precisely, a square root of 200 mm) away from the reference point and the load is rotated around the reference point serving as the rotation center, the rotational moment becomes the same in both cases.

Operations of a three-dimensional object molding apparatus, in a case in which a moment is reproduced, will be described below with reference to the flow chart illustrated in FIG. 21.

First, the molding parameter generating section 12 obtains three-dimensional shape information, arrangement information of each part, and weight information or weight per unit volume information of each part, from the 3D data input section 11 (step S201). Next, the molding parameter generating section 12 obtains information of a reference point having been designated in advance (step S202). Also, the molding parameter generating section 12 obtains weight information of molding materials per unit volume, having been supplied in the three-dimensional object molding apparatus, from the molding material database 14 (step S203). Next, the molding parameter generating section 12 obtains instructions to select either a mode for reproducing moment of force, or a mode for reproducing rotational moment (step S204).

In a case in which the mode for reproducing moment of force has been selected (step S205: YES), the molding parameter generating section 12 obtains a value of moment of force with respect to a reference point from the shape information, the arrangement information, and the weight information, having been obtained (step S206), and, in order to reproduce the obtained value of moment of force, the molding parameter generating section 12 converts the obtained value of moment of force into information which specifies filling rates or mixture proportions of each portion of a molded object (generally, the information is slice data per layer in the case of a three-dimensional object molding apparatus) by using the weight information of the molding materials per unit volume, having been obtained from the molding material database 14 (step S207).

Meanwhile, in a case in which the mode for reproducing rotational moment has been selected (step S205: NO), the molding parameter generating section 12 obtains a value of rotational moment with respect to a reference point from the shape information, the arrangement information, and the weight information, having been obtained (step S208), and, in order to reproduce the obtained value of rotational moment, the molding parameter generating section 12 converts the obtained value of rotational moment into information which specifies filling rates or mixture proportions of each portion of the molded object (generally, the information is slice data per layer in the case of a three-dimensional object molding apparatus) by using the weight information of the molding materials per unit volume, having been obtained from the molding material database 14 (step S209).

Then, the molding parameter generating section 12 controls operations of the head moving mechanism block 20 in accordance with the information which specifies the converted filling rates or mixture proportions of each portion of the molded object, and controls the molding material ejecting section 32 in the molding material handling block 30 so as to eject a desired molding material to a desired position (step S210).

As described above, according to the three-dimensional object molding apparatus in these examples, the weight of a target to be molded is reproduced, and therefore, it is possible to provide a molded object which is closer to the actual object. Further, not only the weight of the target to be molded, but also the position of the center of gravity, texture, and moment of the target to be molded are reproduced, as appropriate, and therefore, not only the exterior appearance, but also the weight, hold-feeling, or feel to use when the molded object is held in one's hands, can be reproduced.

Now, another preferred embodiment of the present invention will be described. According to this preferred embodiment, by using limited information such as “appearance shape”, “supporting condition”, and “weight of molding material per unit volume” so as to control a position of the center of gravity of a molded object when molding, a molded object, which is unstable in a condition such as self-standing, supporting, or suspension, can be kept steady in a stable condition without inclining.

More specifically, a three-dimensional object molding apparatus which is operated via the fused deposition molding (FDM) method, the inkjet method, or the like, is provided with a 3D data input section, a weight balance calculating section, and a molding parameter generating section, and the 3D data input section obtains appearance shape information (hereinafter, referred to as shape information) of a target to be molded based on 3D data, the weight balance calculating section obtains a position of the center of gravity of a molded object based on the shape information of the target to be molded, and calculates a weight distribution of each portion so that the molded object is in a stable condition under designated supporting conditions, and the molding parameter generating section calculates, by using the shape information, the weight distribution information, and the weight information of one or a plurality of molding materials, filling rates or mixture proportions of the molding materials of each portion, and generates molding information to produce the molded object in accordance with the calculated filling rates and mixture proportions.

In such a way, it is possible to provide for the user a molded object in which an appearance design of a target to be molded has been reproduced, and which can also be kept steady in a stable condition.

### EXAMPLE

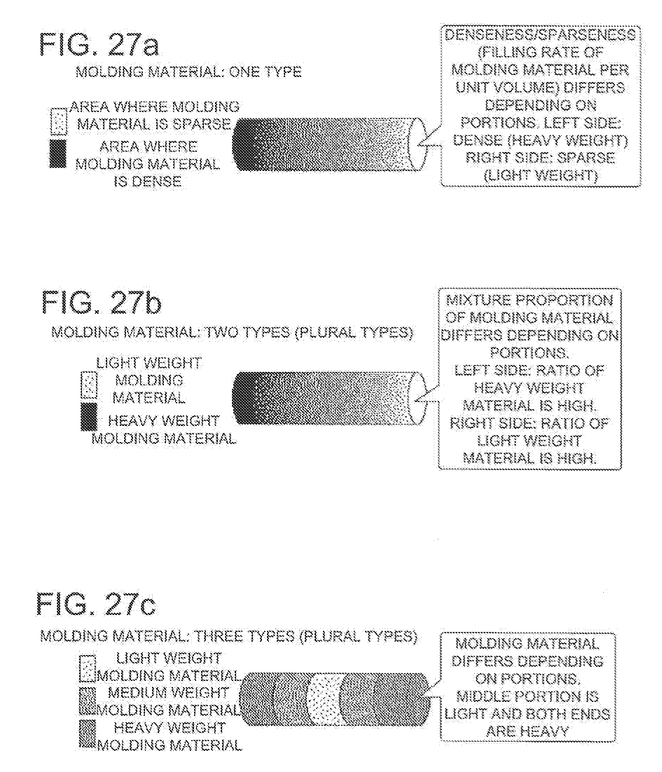

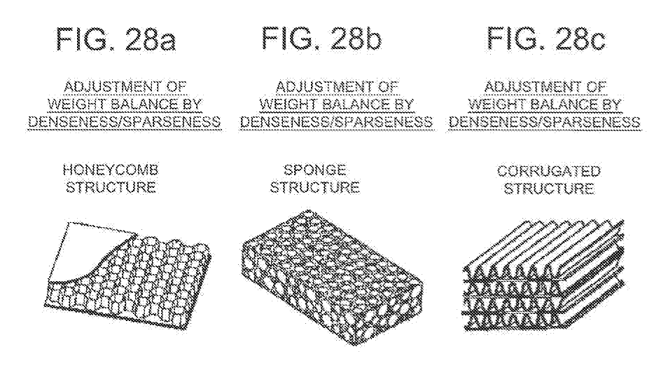

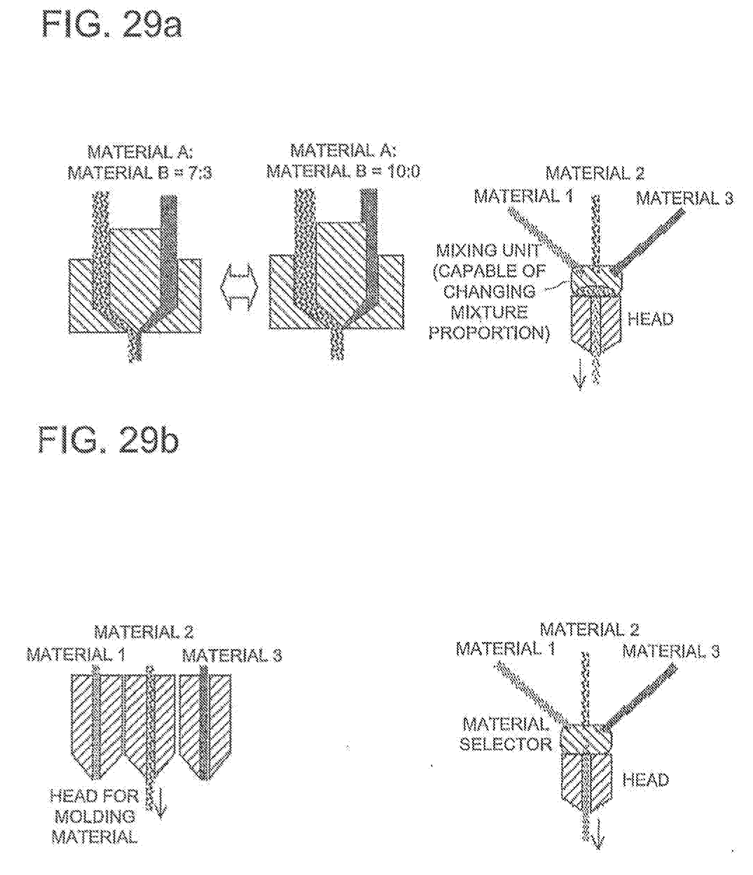

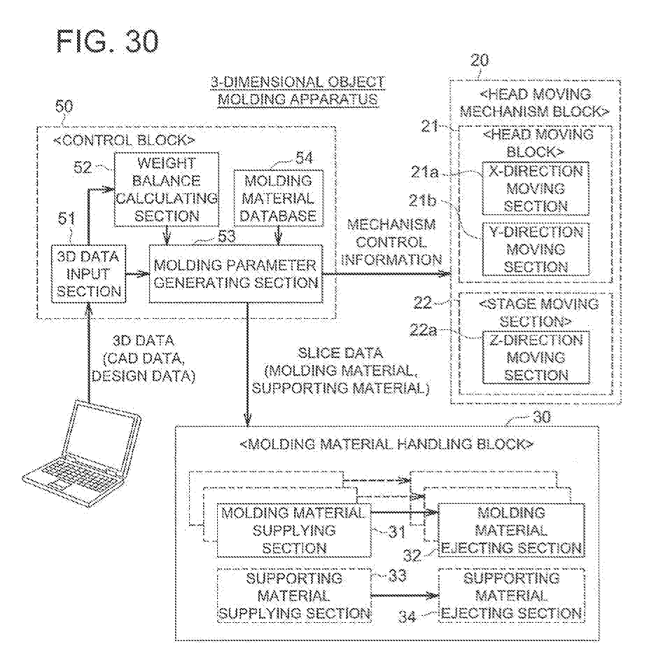

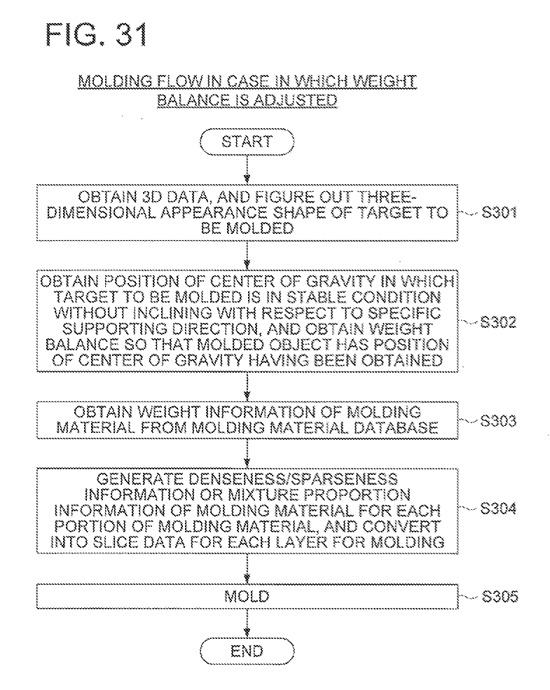

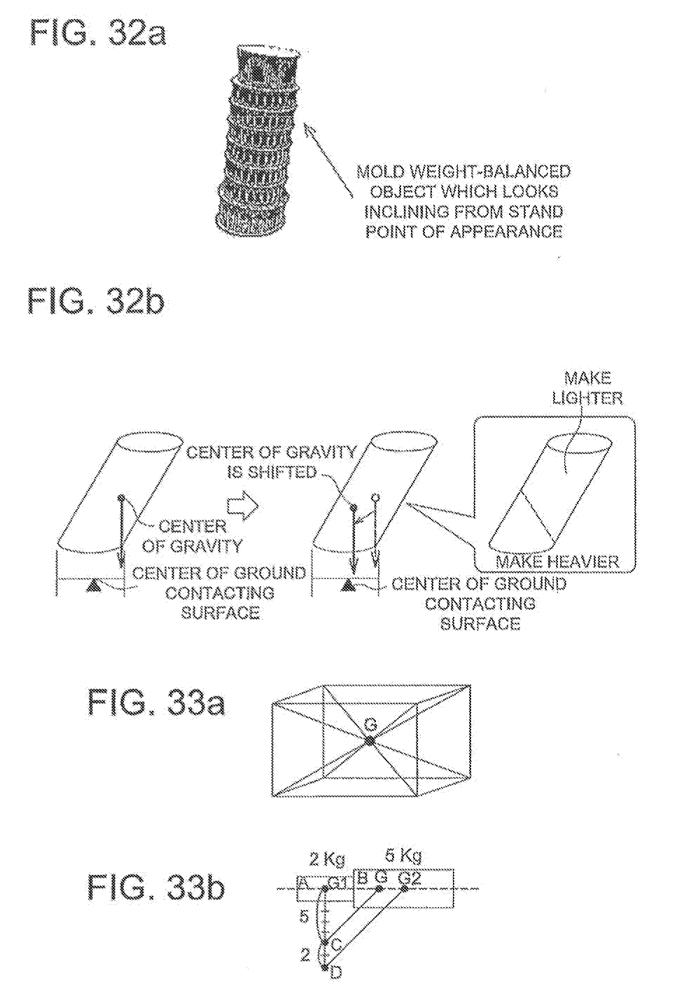

To describe the further details of the aforementioned preferred embodiment of the present invention, the following describes a three-dimensional object molding apparatus and a control program according to one example of the present invention with reference to FIGS. 27a, 27b, and 27c through FIG. 49. FIGS. 27a, 27b, and 27c are explanatory diagrams illustrating variations of methods, by classification, for adjusting a weight balance of a molded object, FIGS. 28a, 28b, and 28c each is a diagram illustrating an example of a structure for adjusting the weight balance by a degree of denseness/sparseness of a molding material, and FIGS. 29a and 29b are diagrams schematically illustrating examples of structures of heads in a case in which the weight balance is adjusted by using a plurality of the molding materials. FIG. 30 is a block diagram illustrating a structure of a three-dimensional object molding apparatus according to this example, and FIG. 31 is a flow chart explaining steps for molding of a three-dimensional object according to this example. FIGS. 32a and 32b through FIG. 49 each is a diagram illustrating a specific example for adjusting the weight balance.

In a case in which a molded object is produced based on a target to be molded, in the present example, the weight balance of the target to be molded is adjusted by entirely or partially changing the filling rate (the degree of denseness/sparseness) or the mixture proportion of the molding material, but it is not limited to the example, and a variety of methods for adjusting the weight balance may be considered. These examples will be described more specifically with reference to FIGS. 27a, 27b, and 27c.

[A Method in which One Type of Molding Material is Used and the Weight of a Molded Object Per Unit Volume is Changed Partially (Refer to FIG. 27a)]

In the case of this method, shape information of a molded object is generated from shape information of each part included in 3D data of the target to be molded, and based on weight information per unit volume of a molding material which has been supplied in the apparatus, and the shape information having been generated, a filling rate of the molding material for each portion is obtained, the entirety of the molded object is produced by molding each portion in accordance with the filling rate having been obtained on a portion to portion basis. To adjust the filling rate, for example, the size of hollows in the honeycomb structure, sponge structure, or corrugated structure, illustrated in FIGS. 28a, 28b, and 28c, respectively, may be partially changed. Also, by elaborating the shape of a head for ejecting a molding material so as to suck in air, and further, by making the amount of air to be sucked in adjustable, hollows may be formed at a ratio according to the portion.

[A Method in which a Plurality of Types of Molding Materials is Used and the Weight of a Molded Object Per Unit Volume is Partially Changed (Refer to FIGS. 27b and 27c)]

In the case of this method, shape information of a molded object is generated from shape information of each part included in 3D data of the target to be molded, and based on weight information per unit volume of a plurality of molding materials which has been supplied in the apparatus, and the shape information having been generated, a mixture proportion of the plurality of the molding materials for each portion is determined, and a molded object is produced by stacking the molding materials having been mixed according to the determined mixture proportion. For example, in a case in which the molding material is ejected from a head, as illustrated in FIG. 29a, the mixture proportion of the plurality of the molding materials may be adjusted in the head according to the portion (refer to the figure in the left), or, by disposing a mixing unit, which mixes the plurality of the molding materials, in a preceding stage of the head, the molding materials, having been mixed via the mixing unit, may be ejected from the head (refer to the figure in the right). Further, as illustrated in FIG. 29b, by injecting each individual molding material into separate heads, a desired molding material may be ejected by switching the head for each individual portion (refer to the figure in the left), or by disposing a material selector, which switches the plurality of the molding materials, in a preceding stage of the head, the molding materials, having been selected via the material selector in accordance with the portion, may be ejected from the head (refer to the figure in the right).

It is to be noted that, when comparing the case, in which one type of molding material is used and the filling rate is changed, with the case in which a plurality of types of molding materials is used and the mixture proportion is changed, although the structure may be simplified in the former case because a molded object can be reproduced by one type of molding material, and therefore, only one ejecting means for molding material is necessary, the upper limit of weight is limited by a state in which a molded object is molded by a filling rate of 100%, and therefore, a problem may arise in which the strength of the molded object may not be ensured if the filling rate is decreased to reduce the weight. On the other hand, in the latter case, the upper limit of weight can be increased by using a heavy-weight molding material, and the strength of the molded object can be enhanced by molding light portions with a light-weight molding material, and therefore, it is possible to prevent the strength of the molded object from deteriorating. As just described, each case has an advantage and a disadvantage, and therefore, it is preferable that whether the former case or the latter case is adopted is determined in accordance with the configuration of a molded object to be produced.

Next, an apparatus which produces a molded object, in which the weight balance of the molded object has been adjusted, by using techniques illustrated in FIGS. 27a, 27b, and 27c. FIG. 30 is a block diagram illustrating a structure of a three-dimensional object molding apparatus according to this example. This three-dimensional object molding apparatus is an apparatus for molding a three-dimensional object by employing a method such as a fused deposition molding (FDM) method, an inkjet method, or the like, and is composed of three blocks, a control block 50, a head moving mechanism block 20, and a molding material handling block 30. Each of the blocks illustrated in FIG. 30 will be described below.

### [Control Block]

The control block 50 is composed of a 3D data input section 51, a weight balance calculating section 52, a molding parameter generating section 53, a molding material database 54, and the like.

The 3D data input section 51 obtains 3D data, in a file format standardized in the industry or in a specific file format unique to each company, the 3D data which is necessary for producing a desired molded object and includes three-dimensional shape information of a target to be molded, from a computer device or the like, and transfers the 3D data to the molding parameter generating section 53, and also transfers the shape information and information which specifies supporting conditions of the molded object to the weight balance calculating section 52. It is to be noted that a method to obtain 3D data is not limited to a specific method, and 3D data may be obtained by employing a wired communication, a wireless communication, a short distance wireless communication such as a Bluetooth (Registered Trade Mark) or the like, or may be obtained by employing a recording medium such as a USB (Universal Serial Bus) memory or the like. Further, this 3D data may be directly obtained from a computer which designs a target to be molded, or may be obtained from a server, which manages and stores 3D data, or the like.

The weight balance calculating section 52 calculates a position of the center of gravity of a closed region (molded object) surrounded by a three-dimensional contour based on the shape information having been obtained from the 3D data input section 51, and adjusts the relative weight of each portion obtained by dividing the inside of the closed region surrounded by the three-dimensional contour so that the entire closed region is weight-balanced. Then, the weight balance calculating section 53 transfers information of the relative weight of each portion after having been adjusted (the information is referred to as weight distribution information) to the molding parameter generating section 53.

The molding parameter generating section 53 specifies a type, a filling rate, and a mixture proportion of a molding material of each portion based on: the shape information, having been obtained from the 3D data input section 51; the weight distribution information, having been obtained from the weight balance calculating section 52; and weight information per unit volume or unit area of one or a plurality of the molding materials, having been obtained from the molding material database 54. Then, based on those information, the molding parameter generating section 53 transmits mechanism control information, which is used for ejecting the molding material to a desired position, to the head moving mechanism block 20, and also transmits data which specifies the molding material on a layer to layer basis (the data is referred to as slice data), to the molding material handling block 30.

The aforementioned 3D input section 51, the weight balance calculating section 52, and the molding parameter generating section 53 may be constituted as a hardware, or may be constituted as a control program which functions as the 3D input section 51, the weight balance calculating section 52, and the molding parameter generating section 53, and such control program may be made to be operated in a three-dimensional object molding apparatus, or in an apparatus which controls such three-dimensional object molding apparatus.

The molding material database 54 stores weight information per unit volume, or per unit area, of one or a plurality of molding materials, to be used for molding, and provides the molding parameter generating section 53 with the stored information. It is to be noted that the molding material database 54 is not necessarily installed in the interior of the three-dimensional object molding apparatus, and if it is possible to refer to the molding parameter generating section 53, the molding material database 54 may be installed outside the three-dimensional object molding apparatus.

The head moving mechanism block and the molding material handing block in FIG. 30 are substantially the same as the head moving mechanism block and the molding material handing block in FIG. 4, and therefore, the explanations are omitted.

Next, steps for producing a molded object, in which the weight balance has been adjusted, by using the aforementioned three-dimensional object molding apparatus, will be described with reference to the flow chart illustrated in FIG. 31.

First, by using a computer device, 3D data, such as CAD data, design data, or the like, of a target to be molded, is generated.

The 3D data, generated at the computer device, is taken by the control block 50 (3D data input section 51) of the three-dimensional object molding apparatus, and the shape of the target to be molded is figured out based on the 3D data. Then, shape information is transmitted to the molding parameter generating section 53 (step S301). Also, the shape information and information of supporting conditions (supporting surface and supporting direction), having been embedded into the 3D data or having been designated by the user, are sent to the weight balance calculating section 52. It should be noted that the aforementioned supporting conditions mean, but not limited to, a ground contacting surface, supporting point, supporting direction, and the like, in cases in which a molded object for display purpose is supported in a method such as “placing”, “supporting”, “suspending”, or the like.

The weight balance calculating section 52 adjusts the weight (the weight per unit volume or per unit area) of each of the three-dimensional portions without changing the three-dimensional shape of the target to be molded (step S302). For example, the weight balance calculating section 52 calculates the position of the center of gravity in cases in which the entire molded object is molded with a molding material having a uniform weight (weight per unit volume or per unit area is the same in the entire molded object), or calculates a weight distribution of each of the portions of the molded object, the weight information which is necessary for changing the position of the center of gravity to a desired position.

More specifically, in cases in which a target to be molded is for display purpose, it is required that a molded object, reproduced based on the target to be molded, do not incline easily or fall even if an earthquake occurs or other external forces are applied to the molded object. To display the molded object in a balanced manner and stably, it is preferred that a molded object be not produced with a molding material having a uniform weight (weight per unit volume or per unit area is the same in the entire molded object), and that the weight balance be adjusted by changing the weight (weight per unit volume or per unit area) on a portion to portion basis so that the position of the center of gravity of the molded object has a desired relationship with respect to the ground contacting surface. For example, in a case in which a molded object is a stationary article supported by a surface, it is preferred that the vertical line passing through the center of gravity match with or be adjacent to the center of the ground contacting surface. Also, in a case in which a molded object is supported from below by a point, or supported by being suspended from a point above, it is preferred that the vertical line passing through the center of gravity substantially match with or be adjacent to the supporting point. Therefore, in the weight balance calculating section 52, weight balance is obtained in which the molded object is kept steady in a stable condition, by changing the weight of each portion without molding the entirety of the molded object with a molding material having a uniform weight.

The molding parameter generating section 53 obtains weight information per unit volume of a molding material, to be used, from the molding material database 54 (step S303). Then, based on the shape information which has been obtained after analyzing the 3D data, the weight distribution information which has been obtained from the weight balance calculating section 52, and the weight information of the molding material which has been obtained from the molding material database 54, the molding parameter generating section 53 reproduces the shape of the molded object, and converts into molding information (mechanism control information for the head moving mechanism block 20, and slice data for the molding material handling block 30) which specifies that a molding material of what filling rate or mixture proportion is to be ejected to what position so as to reproduce the obtained weight balance (step S304). Then, when the conversion is complete, the flow proceeds to the actual molding operation (step S305).

For example, in a case of a three-dimensional object molding apparatus in which a molding material which has been melted by heat is ejected and stacked, or in which an ultraviolet curable resin is ejected from a molding head, and the resin is solidified by being irradiated with an UV lamp, the ejection position of a molding material is moved in a three-dimensional manner, and, simultaneously, the molding material is ejected and stacked. Also, in a case in which a molded object is molded by using one type of molding material, this case may also be applied to: a method in which an UV curable resin, stored in a tank, is irradiated with an ultraviolet laser and stacked; a method in which a powdered molding material, stored in a tank, is dissolved by a laser; and a method in which an adhesive, which is referred to as a binder, is applied and stacked.

In this way, in this example, by using the shape information, supporting condition information, and weight information of a molding material per unit volume, a molded object which is unstable in a condition such as self-standing, supporting, or suspension, can be kept steady in a stable condition without inclining. It is to be noted that although a method, in which a molded object is made to stand by itself by changing the shape of the ground contacting surface, or by adding a supporting member, can be considered as a method in which a molded object is mate to stand by itself, in this example, it becomes possible to produce a molded object which stands stably by itself while maintaining the original three-dimensional shape. A description will be given below by making reference to a concrete example.

First, an example will be described, in which a model of an inclined building, as illustrated in FIG. 32a, is produced. In a case in which the entire region of an inclined object in a cylindrical shape or in a circular cylindrical shape is molded by a material having a uniform weight (as an example, a weight per unit volume of 5 g/cm³), the center of gravity is positioned roughly in the center of the three-dimensional object, and therefore, the object tends to fall easily as illustrated in the figure on the left. On the other hand, in a case in which the object in a cylindrical shape or in a circular cylindrical shape is region-divided at the position indicated by the dashed line as illustrated in the figure on the right, and the object is molded by decreasing the weight per unit volume of the upper portion (as an example, 2 g/cm³), and by increasing the weight per unit volume of the lower portion (as an example, 7 g/cm³), the position of the center of gravity approaches the center of the ground contacting surface, and therefore, the object is prevented from falling.

Here is an explanation on how the center of gravity is obtained. An object is composed of small molecules, and the force of gravity is applied to each of the molecules. The point where those forces of gravity are concentrated is the point of application that is the center of gravity. For the case of a three-dimensional object, the constitution of the object is divided into micro-volumes and the center of gravity of each of the micro-volumes is obtained, and then, the center of gravity of the entire object can be obtained from the resultant force. The center of gravity of each individual micro-volume is the position of the point of intersection of the diagonal lines, as illustrated in FIG. 33a. It is to be noted that although an accuracy of the calculation of the center of gravity increases as the constitution of the object is divided into smaller micro-volumes, the amount of calculation increases, and therefore, the volume may be fixed to 1 cm³, as an example, or the number of the micro-volumes may be fixed in such a manner that the constitution of the object is divided into 100 in each direction of x, y, and z.

Also, in the case of an object having a shape as illustrated in FIG. 33b, the object is divided into two portions, A and B, and the centers of gravity G1 and G2 are obtained from the points of intersection of respective diagonal lines. Next, an arbitrary straight line G1-D is drawn from the center of gravity G1 of A, and further, a point C, where the ratio by weight is reversed on the line G1-D, is obtained. Then, subsequently, a straight line C-G, which is parallel to a line D-G2, is drawn from the point C, and the point of intersection which intersects with G1-G2 is obtained. In this way, the center of gravity G of an object which has portions of different shapes can be obtained.

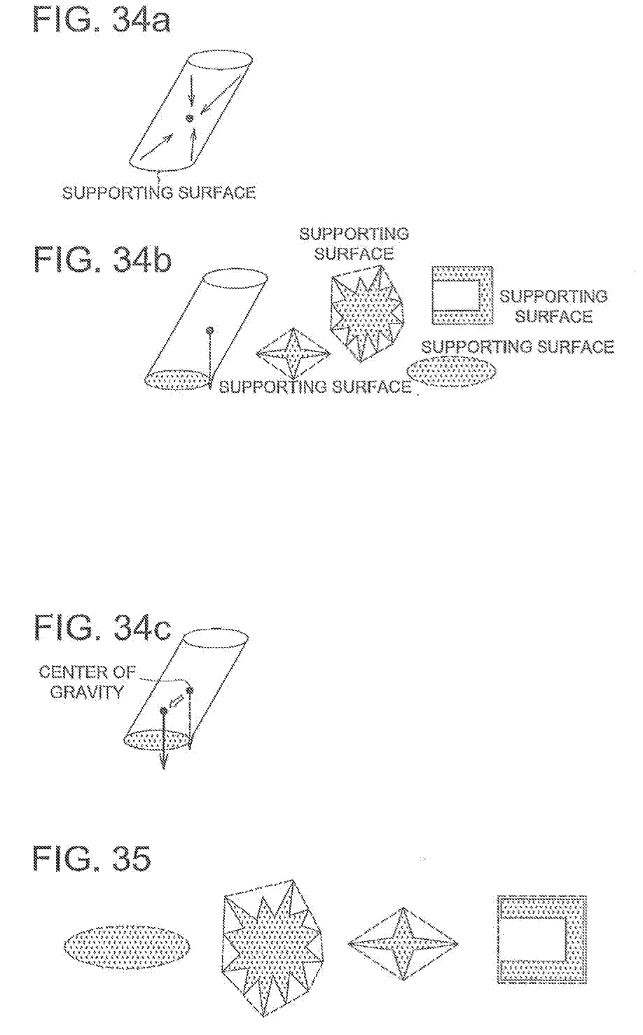

Next, a method for adjusting the center of gravity of a three-dimensional object in a cylindrical shape or in a circular cylindrical shape will be described. First, as illustrated in FIG. 34a, the center of gravity of the three-dimensional object is obtained in the case in which the three-dimensional object is molded uniformly. As described above, the center of gravity can be obtained by dividing the entire object into regions of micro-volumes, and by finding a position where the moments to the centers of gravity of the entire micro regions balance to each other.

Next, as illustrated in FIG. 34b, a surface (supporting surface) on which the three-dimensional object can stand by itself is specified. At that time, in cases in which the supporting surface is a shape including peaks, an area surrounded by the dashed line formed by connecting the peaks of the supporting surface is obtained. Then, it is determined whether or not the vertical line passing through the center of gravity, having been obtained previously, passes through the area surrounding the supporting surface. It can be determined that the three-dimensional object stands by itself if the vertical line passes through the area, and that the three-dimensional object does not stand by itself if the vertical line does not pass through the area. A method for designating a supporting surface will be described later.

Next, as illustrated in FIG. 34c, in a case in which a molded object does not stand by itself, the weight balance is changed in such a manner that the vertical line passing through the center of gravity intersects with the area surrounding the supporting surface, by molding the object non-uniformly so as to shift the position of the center of gravity.

Here, as minimum requirements for a molded object, having a supporting surface (ground contacting surface), to stand by itself without falling, in a case in which the molded object is placed with its supporting surface facing downward, it is necessary that a line drawn from the position of the center of gravity in the vertical direction intersect with the inside of the surface surrounded by a line (dashed line in the figure) formed by connecting the outer circumference or peaks of the supporting surface, as illustrated in FIG. 35.

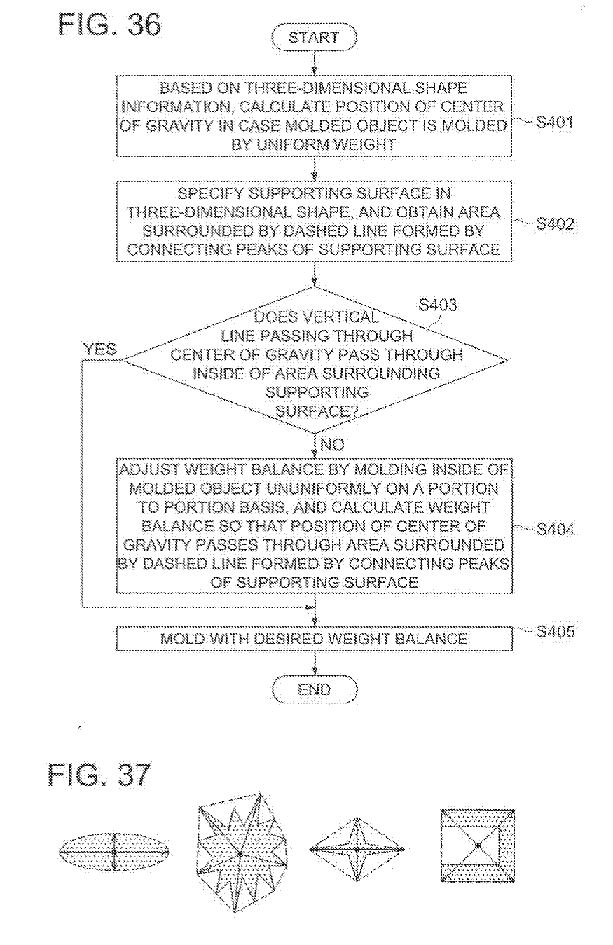

Operations of the three-dimensional object molding apparatus in this case will be described with reference to the flow chart illustrated in FIG. 36. First, the weight balance calculating section 52 calculates the position of the center of gravity in the case in which the entire 3D shape is molded by a uniform weight (step S401), specifies the supporting surface in the 3D shape, and obtains the area formed by connecting the peaks of the supporting surface (step S402). Next, the weight balance calculating section 52 determines whether or not the vertical line passing through the center of gravity passes through the inside of the area surrounding the supporting surface (determines whether or not the molded object stands by itself from the positional relation of the position of the center of gravity and the supporting surface) (step S403), if it has been determined that the molded object does not stand by it self (step S403: NO), the weight balance calculating section 52 changes the weight distribution of each portion of the molded object so that the position of the center of gravity shifts to the inside of the supporting surface (step S404). Then, the molding parameter generating section 53 generates mechanism control information which controls the head moving mechanism block 20, and slice data which controls the molding material handling block 30, and the molded object is molded with a desired weight balance (step S405).

Also, as minimum requirements for a molded object, having a supporting surface (ground contacting surface), to stand by itself stably, in a case in which the molded object is placed with its supporting surface facing downward, it is important that a line drawn from the position of the center of gravity in the vertical direction pass through a position which is as near as possible to the dynamic focus (black circle in the figure) of the supporting surface, as illustrated in FIG. 37.

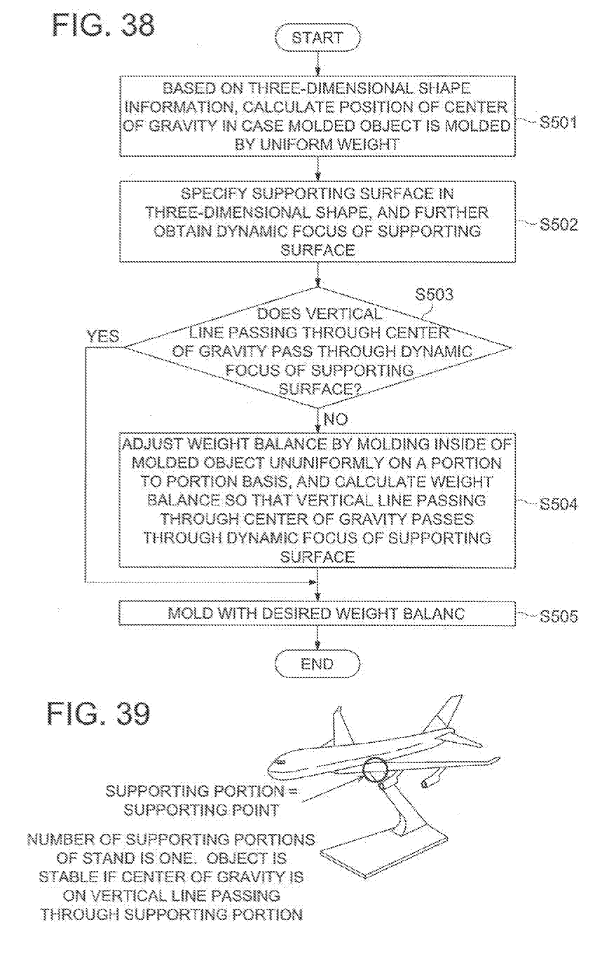

Operations of the three-dimensional object molding apparatus in this case will be described with reference to the flow chart illustrated in FIG. 38. First, the weight balance calculating section 52 calculates the position of the center of gravity in the case in which the entire 3D shape is molded by a uniform weight (step S501), specifies the supporting surface in the 3D shape, and obtains the position of dynamic focus of the supporting surface (step S502). Next, the weight balance calculating section 52 determines whether or not the vertical line passing through the position of the dynamic focus (determines whether or not the molded object stands by itself stably enough from the positional relation of the position of the center of gravity and the dynamic focus of the supporting surface) (step S503), if it has been determined that there is a room to make the molded object further stable by changing the position of the center of gravity (step S503: NO), the weight balance calculating section 52 changes the weight distribution of each portion of the molded object so that the vertical line passing through the center of gravity comes closer to the dynamic focus of the supporting surface (step S504). Then, the molding parameter generating section 53 generates mechanism control information which controls the head moving mechanism block 20, and slice data which controls the molding material handling block 30, and the molded object is molded with a desired weight balance (step S505).

Although the case has been described above, in which a molded object is made to stand by itself on a supporting surface, as a method to display a molded object, there are methods such as a method in which a molded object is supported from below by a point, and a method in which a molded object is suspended from above. In the case in which a molded object is supported from below by a supporting surface (ground contacting surface), although a vertical direction against the supporting surface is a supporting direction and the supporting direction can be determined unambiguously, in the case in which a molded object is supported by a point or suspended from above, additional information with respect to the supporting direction is needed. Therefore, in this example, after clarifying the direction and position to support a molded object, the molded object is produced with a preferable center of gravity with respect to the supporting direction and the supporting point.

FIG. 39 is a diagram illustrating an example of a molded object supported from below by one point. In this case, the molded object becomes most stable in a case in which the center of gravity of molded object is located directly above a supporting portion, or in a vertical direction of the supporting portion, and a stress applied to the supporting point increases with distance from the center of gravity to that position, and the molded object tends to fall easily. Therefore, the weight balance calculating section 52 calculates the weight balance in which the center of gravity of molded object matches with or comes closer to a desirable position, in which the molded object is stable when displayed, so as to mold a stable molded object.

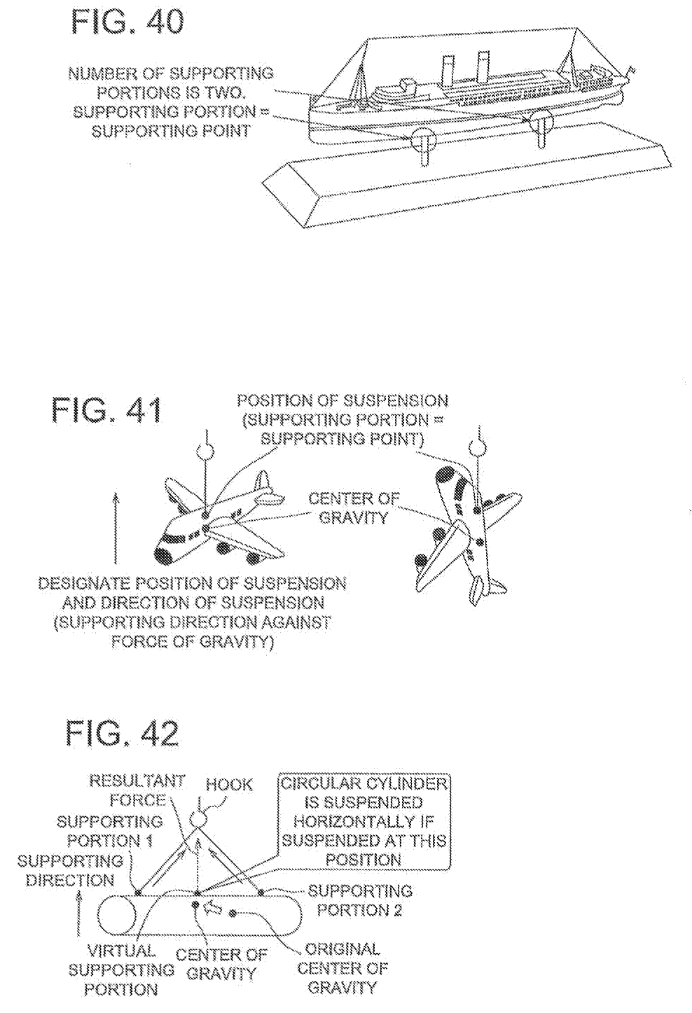

FIG. 40 is a diagram illustrating an example of a molded object supported from below by a plurality of points. In this case, the center of gravity of a molded object is always one point, and therefore, in the case of a plurality of supporting portions (supporting points), a virtual supporting portion, which takes into account a resultant force of the plurality of supporting portions, is considered (normally, the virtual supporting portion is an intermediate point between two supporting portions). Then, the weight balance calculating section 52 calculates the weight balance, in which the center of gravity of molded object matches with or comes closer to the vertical line passing through the virtual supporting portion, so as to mold a stable molded object.

FIG. 41 is a diagram illustrating an example of a molded object supported by being suspended by one point. In the case in which a molded object is suspended by one point, a position of suspension and a direction of suspension (supporting direction against force of gravity) are designated. The supporting direction is needed to be designated because, without the direction, a situation as illustrated in the figure on the right may occur. In this case, a most stable case is the case in which the center of gravity of molded object is located directly below the position of suspension or is in a vertical direction of the supporting portion, and a stress applied to the point of suspension increases with distance from the position of the center of gravity to that position, and the molded object tends to incline easily. Therefore, the weight balance calculating section 52 calculates the weight balance, in which the center of gravity of molded object matches with or comes closer to the position of suspension, so as to mold a stable molded object.

FIG. 42 is a diagram illustrating an example of a molded object supported by being suspended by a plurality of points. In a case in which a molded object is suspended by two points, a resultant force, applied to the two supporting points, is applied to a hook. When the molded object is arranged in a direction suitable for display, a most stable case is the case in which the resultant force applied to the hook matches with the vertical line passing through the hook, and the center of gravity of the molded object is placed to the position where the resultant force or the vertical line intersects with the molded object, and a stress applied to the two supporting portions increases with distance from the position of the center of gravity to that position and the molded object tends to incline easily. Therefore, the weight balance calculating section 52 calculates the weight balance, in which the center of gravity of molded object matches with or comes closer to a desirable position, in which the molded object is stable when displayed, so as to mold a stable molded object.

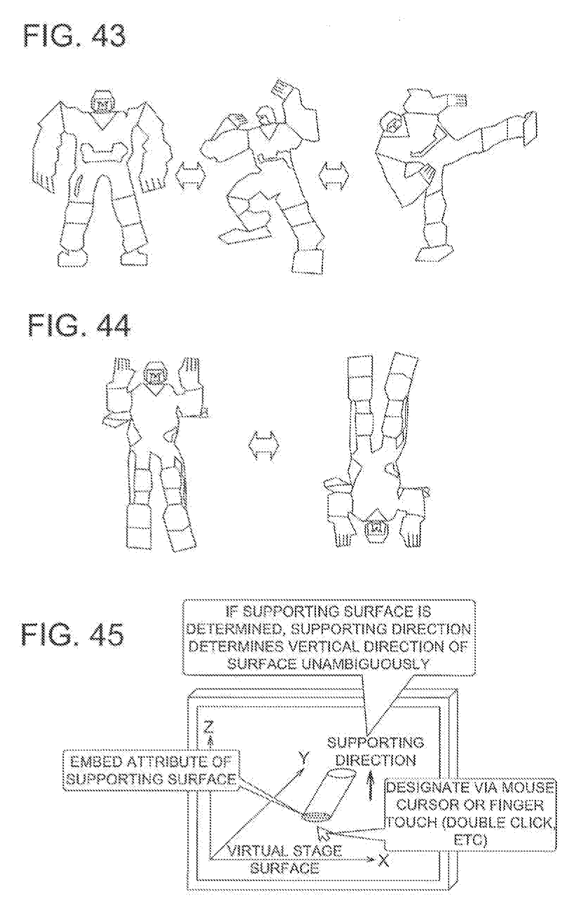

Although the case, in which a molded object has a fixed shape, has been described above, there may be a molded object to which one or a plurality of portions are connected movably, and the molded object may have a plurality of shapes by the movement of one or plural portions. For example, in a case in which a model of a robot or a doll is molded, as illustrated in FIG. 43, the area, where the molded object stands by itself, is increased by bringing the center of gravity to an intermediate point even in a case of a pause which tends to incline from front to back and from side to side. Also, as illustrated in FIG. 44, by bringing the center of gravity to an intermediate point, the molded object can be kept steady in a stable condition even in a standing position, in a lay down position, or in a handstand position.

In this case, the weight balance calculating section 52 calculates a most appropriate position of the center of gravity for each state of movement of a molded object having a plurality of shapes for display (a molded object having a movable portion), and based on the calculated position of the center of gravity, the weight balance calculating section 52 calculates a virtual position (normally, an intermediate position) of the center of gravity in accordance with predetermined calculation formulas, and molds a molded object by adjusting weight distribution of each portion in such a manner that the calculated position becomes the position of the center of gravity, so that it is possible to mold a molded object which is kept steady in a stable condition in a plurality of movable positions.

However, each individual appropriate position of the center of gravity, having been obtained in the plurality of movable positions, does not match with the intermediate position, obtained from calculation, and therefore, the stability with respect to each of the movable positions may deviate from the best case. However, if a molded object is molded in conformity with one movable position, the molded object may not stand by itself in another movable position, or may be extremely unstable. This method improves these cases and it becomes possible to provide a molded object which is kept steady in a relatively stable condition in a plurality of movable positions.

Although a variety of methods for adjusting weight balance has been described above, as previously described, it is necessary to specify a supporting surface (supporting portion) and a supporting direction to adjust the weight balance of a molded object for display purpose. A method to designate the supporting surface (supporting portion) and the supporting direction will be more specifically described below.

As a method to designate a supporting surface, as illustrated in FIG. 45, there is a method in which an attribute, indicating to be a supporting surface, is embedded in a specific surface of a molded object at the time of three-dimensional shape data generation. For example, an attribute of a supporting surface is embedded in the bottom surface of an inclined circular cylinder. This method is a method in which a specific surface is designated via a click of a mouse cursor, a touch operation on a touch panel, or the like, on a screen for an arrangement operation of how to arrange a molded object within a molding area, the operation which is to be carried out before molding.

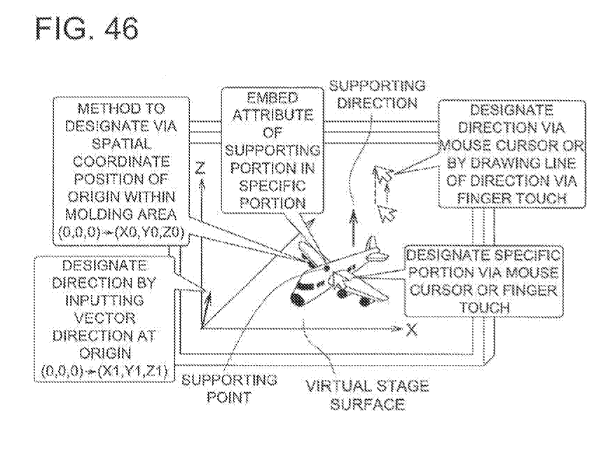

Also, as a method to designate a supporting direction, as illustrated in FIG. 46, there is a method in which an attribute, indicating to be a supporting portion, is embedded in a specific portion of a molded object at the time of three-dimensional shape data generation, and also, information of supporting direction of the molded object is embedded in file data. This method is a method in which a specific portion is designated via a click of a mouse cursor, a touch operation on a touch panel, or the like, on a screen for an arrangement operation of how to arrange a molded object within a molding area, the operation which is to be carried out before molding, and also a supporting direction is designated via a click of a mouse cursor, or an operation for drawing a line of direction on a touch panel. Further, in this method, it is possible to designate a supporting direction via a vector value at an origin by designating the supporting portion via a spatial coordinate position of the origin as a reference within the molding area.

In the cases of these designating methods as described above, processing for realizing a balanced molded object can also be carried out without any problem. However, these methods have not been necessary for a conventional 3D printer in which weight balance at the time of installation is not considered. Therefore, a method to simplify the designating operation is proposed. In other words, because the operation itself for arranging a molded object within a molding area on a computer device before molding is an operation which is also carried out in a conventional 3D printer, by using this arrangement operation as a substitute for the designating operation, it is possible to simplify the designating operation.

### [Method to Omit the Designation of Supporting Surface]

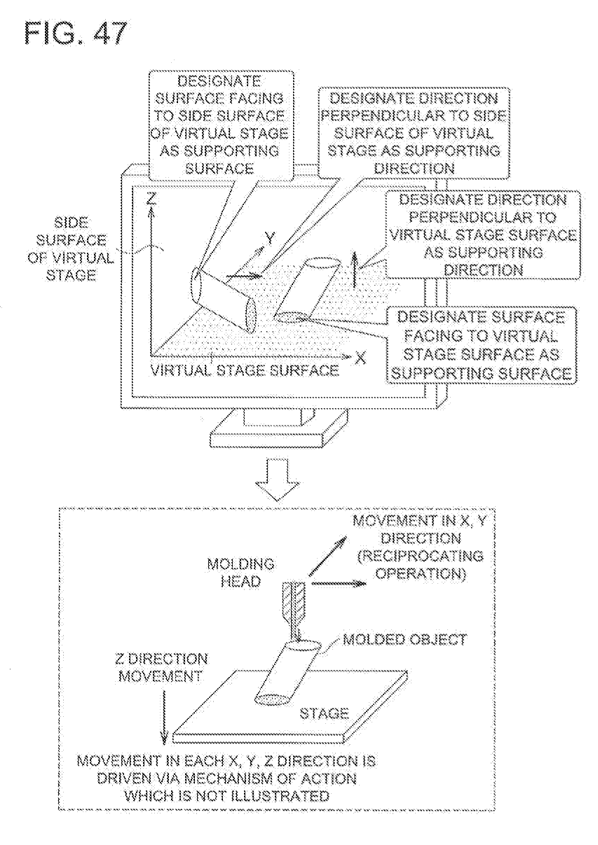

More specifically, in order to simplify the designation of supporting surface, as illustrated in FIG. 47, a surface facing to a virtual stage surface is set as a supporting surface in advance. In this method, in an operation for arranging a molded object in a molding area on a computer device, it is possible to determine the supporting surface unambiguously by only arranging in such a manner that a molded object is molded in the same direction as a direction of actual display of the molded object when completed. Also, a specific surface (for example, a side surface of the virtual stage), with respect to the virtual stage surface, may also be designated in advance to be a supporting surface of the molded object. In this method, in the operation for arranging a molded object in a molding area on a computer device, it is possible to determine the supporting surface unambiguously by only arranging a molded object so as to be inclined by 90 degrees with respect to the direction for displaying the molded object when completed.

### [Method to Omit the Designation of Supporting Direction]

More specifically, in order to simplify the designation of supporting direction, as illustrated in FIG. 47, a supporting direction perpendicular to a virtual stage surface is set as a supporting direction in advance. In this method, in an operation for arranging a molded object in a molding area on a computer device, it is possible to determine the supporting direction unambiguously by only arranging in such a manner that a molded object is molded in the same direction as a direction of actual display of the molded object when completed. Also, a direction, perpendicular to a specific surface (for example, a side surface of the virtual stage) with respect to the virtual stage, may also be designated in advance to be a supporting direction of the molded object. In this method, in the operation for arranging a molded object in a molding area on a computer device, it is possible to determine the supporting direction unambiguously by only arranging a molded object so as to be inclined by 90 degrees with respect to the direction for displaying the molded object when completed.

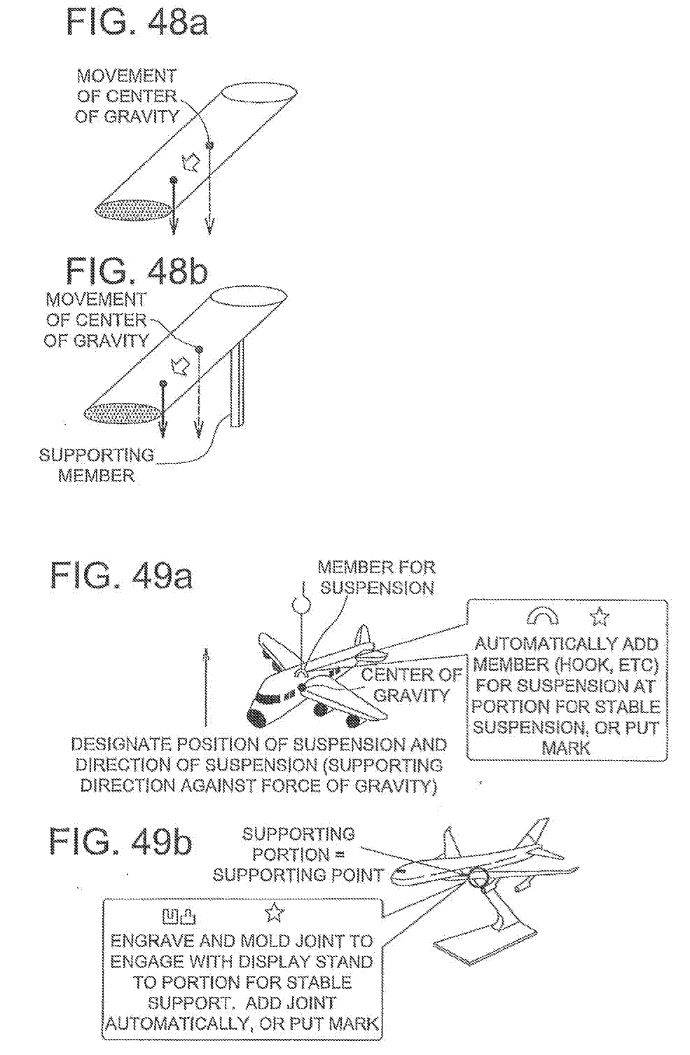

Although a variety of methods for molding a molded object which stands by itself by adjusting weight balance has been described above, as illustrated in FIG. 48a, because a molded object inclines, even if the position of the center of gravity is moved by carrying out a balance adjustment by changing the filling rate or mixture proportion of a molding material, the molded object may not stand by itself, or may not be stable enough. In this case, as illustrated in FIG. 48b, a supporting member, serving as a fall-prevention member, may be added automatically.

Also, with respect to a molded object to be suspended, as illustrated in FIG. 49a, a member for suspension may be added to the upper side of the position of the center of gravity, in which the weight balance has been adjusted. Or, a mark may be added to the upper side of the position of the center of gravity, in which the weight balance has been adjusted, so that it becomes easy to find an appropriate area for the addition of the member for suspension. Further, as illustrated in FIG. 49b, a joint to engage with a support stand may be added to the lower side of the position of the center of gravity, in which the weight balance has been adjusted. Or, a mark may be added to the lower side of the position of the center of gravity, in which the weight balance has been adjusted, so that it becomes easy to find an appropriate area for the addition of the joint to engage with a support stand.

Although the examples of the preferred embodiments of the present invention have been described by way of the accompanying drawings, it should be noted that specific structures are not restricted to those shown in the examples of the preferred embodiments. Various changes and modifications should be construed as being contained in the present invention unless such changes and modifications depart from the scope of the present invention.

For example, although three-dimensional object molding apparatuses utilizing a method such as a fused deposition molding (FDM) method and an inkjet method have been described in the examples described above, the present invention is applicable to any kind of method in which a molding material is stacked by adjusting a filling rate and/or mixture proportion.

### INDUSTRIAL APPLICABILITY

The present invention applies to a three-dimensional object molding apparatus, such as a 3D printer to mold a three-dimensional object, or the like, and a control program run by the aforementioned apparatus.

What is claimed is:

1. A non-transitory computer-readable recording medium recorded therein a program that causes a computer to enable functions of a) a three-dimensional object molding apparatus configured to mold a three-dimensional object by sequentially stacking at least one molding material, or b) a control section for controlling said three-dimensional object molding apparatus, the functions comprising:
inputting an information comprising a three-dimensional shape information of a target to be molded necessary to produce the desired molded object; and
generating molding parameters by: a) calculating a filling rate indicating a degree of dense or sparse of said at least one molding material, or a mixture proportion of a plurality of said at least one molding material, based on the information necessary to produce a desired molded object, having been obtained from said inputting of the information comprising the three-dimensional shape information of the target to be molded and weight information of said at least one molding material having been obtained from a molding material database; and b) generating molding information for stacking said at least one molding material in accordance with said filling rate or said mixture proportion having been calculated; and
stacking said at least one molding material in accordance with said molding information.

2. The non-transitory computer-readable recording medium described in claim 1, wherein:
the desired molded object is a molded object having an identical weight as that of said target to be molded;
in said inputting, a weight information per unit volume of the target to be molded, or a weight information of an entire weight of the target to be molded is input as a necessary information to produce the desired molded object; and
said generating molding parameters comprises generating said molding information capable of producing said molded object having the identical weight as that of said target to be molded, based on the shape information and the weight information of said target to be molded, having been obtained from said inputting, and the weight information of said at least one molding material having been obtained from said molding material database.

3. The non-transitory computer-readable recording medium described in claim 1, wherein:
said inputting comprises input of a three-dimensional shape information of each part which constitutes said target to be molded, and input of a weight information of each part or a weight information per unit volume of each part; and
said generating molding parameters comprises: a) calculating a filling rate of each part of said at least one molding material, the filling rate producing a molded object having an identical weight as that of said target to be molded, based on the shape information and the weight information of each part of said target to be molded, and the weight information of said at least one molding material; and b) to generate a molding information for stacking said molding material in accordance with said filling rate of each part, said filling rate of each part having been calculated.

4. The non-transitory computer-readable recording medium described in claim 3, wherein:
said inputting comprises input of an arrangement information of each part that constitutes said target to be molded; and
said generating molding parameters comprises: a) identifying a position of the center of gravity of said target to be molded based on the arrangement information and the weight information of each part of said target to be molded; and b) calculating a filling rate of each part of said molding material, the filling rate producing a molded object having an identical weight and position of the center of gravity of said target to be molded, based on the shape information and the weight information of each part of said target to be molded, the weight information of said at least one molding material, and the position of the center of gravity of said target to be molded, having been identified.

5. The non-transitory computer-readable recording medium described in claim 1, wherein:
said inputting comprises input of a three-dimensional shape information of each part that constitutes said target to be molded, and a weight information of each part or a weight information per unit volume of each part; and
said generating molding parameters comprises: a) calculating a mixture proportion of each part of said plurality of said at least one molding material, the mixture proportion producing a molded object having an identical weight as that of said target to be molded, based on the shape information and the weight information of each part of said target to me molded and the weight information of the plurality of said at least one molding material; and b) generating a molding information for stacking said at least one molding material in accordance with said mixture proportion of each part, having been calculated.

6. The non-transitory computer-readable recording medium described in claim 5, wherein:
said inputting comprises input of an arrangement information of each part that constitutes said target to be molded; and
said generating molding parameters comprises: a) identifying a position of the center of gravity of said target to be molded based on the arrangement information and the weight information of each part of said target to be molded; and b) calculating a mixture proportion of said plurality of said at least one molding material, the mixture proportion producing a molded object having an identical weight and position of the center of gravity of said target to be molded, based on the shape information and the weight information of each part of said target to be molded, the weight information of said plurality of said at least one molding material, and the position of the center of gravity of said target to be molded, having been identified.

7. The non-transitory computer-readable recording medium described in claim 5, wherein said generating molding parameters comprises increasing a volume of said molding material, having a greatest weight per unit volume among said plurality of said at least one molding material, in a case in which a predetermined part has a greater weight per unit volume than any one of said at least one molding material, so that it is possible to produce a molded object having an identical weight as that of said target to be molded, or an identical weight and position of the center of gravity as those of said target to be molded.

8. The non-transitory computer-readable recording medium described in claim 3, wherein, in a case in which a plurality of parts is exposed on a surface of said target to be molded, said generating molding parameters comprises: a) having a uniform filling rate of said at least one molding material or a uniform mixture proportion of said plurality of said at least one molding material, of exposed portions of said plurality of parts; and b) adjusting the filling rate of said molding material or the mixture proportion of said plurality of said at least one molding material, of a portion other than said exposed portions so that it becomes possible to produce a molded object having an identical weight as that of said target to be molded, or an identical weight and position of the center of gravity as those of said target to be molded, while maintaining a uniform texture of the entire molded object.

9. The non-transitory computer-readable recording medium described in claim 1, wherein said generating molding parameters comprises changing the filling rate of said at least one molding material or the mixture proportion of said plurality of said at least one molding material between a surface portion on which said at least one molding material is exposed and an interior portion other than said surface portion, so as to adjust texture and/or strength of the molded object.

10. The non-transitory computer-readable recording medium described in claim 1, wherein said generating molding parameters comprises generating molding information for stacking said at least one molding material having an identical filling rate or mixture proportion, per layer, or per line, or per dot.

11. The non-transitory computer-readable recording medium described in claim 1, wherein the functions further comprise setting a specific portion inside said target to be molded as a reference point, wherein said generating molding parameters comprises: a) calculating a moment with a reference point, designated by said reference point setting section, as a starting point, based on the shape information and the weight information of said target to be molded; and b) calculating a filling rate of said molding material or a mixture proportion of said plurality of said at least one molding material, the filling rate and the mixture proportion producing a molded object having an identical weight and moment as that of said target to be molded, based on the shape information and the weight information of said target to be molded, the weight information of said at least one molding material, and the moment of said target to be molded, having been calculated.

12. The non-transitory computer-readable recording medium described in claim 1, wherein the desired molded object is a molded object that is in a stable condition with respect to a specific supporting direction, and the functions further comprise weight balance calculating by: a) obtaining a position of the center of gravity of a molded object having an identical shape as that of said target to be molded based on the shape information of said target to be molded, having been obtained from said inputting; and b) calculating a weight distribution of each portion of said molded object so that said molded object is in a stable condition with respect to a specific supporting direction, wherein said generating molding parameters comprises generating molding information for producing a molded object which is in the stable condition with respect to the specific supporting direction based on the shape information of said target to be molded, the weight distribution information having been calculated, and the weight information of said at least one molding material having been obtained from said molding material database.

13. The non-transitory computer-readable recording medium described in claim 12, wherein, in a case in which said molded object is made to stand by itself on a pre-designated supporting surface, said weight balance calculating comprises calculating a weight distribution of each portion of said molded object so that the point, located on an extension of the position of the center of gravity of said molded object in the vertical direction, is arranged inside an area surrounded by a line formed by connecting the outer circumference or peaks of said supporting surface.

14. The non-transitory computer-readable recording medium described in claim 12, wherein said weight balance calculating section comprises calculating the weight distribution of each portion of said molded object so that the point, located on an extension of the position of the center of gravity of said molded object in the vertical direction, coincides with or approaches the center point of said supporting surface.

15. The non-transitory computer-readable recording medium described in claim 12, wherein, in a case in which said molded object is supported by one supporting portion designated in advance, said weight balance calculating comprises calculating the weight distribution of each portion of said molded object so that the point, located on an extension of the position of the center of gravity of said molded object in the vertical direction, coincides with or approaches said supporting portion.

16. The non-transitory computer-readable recording medium described in claim 12, wherein, in a case in which said molded object is supported by a plurality of supporting portions designated in advance, said weight balance calculating comprises: a) obtaining one virtual supporting portion in which said molded object is in a stable condition with respect to said specific supporting direction; and b) calculating a weight distribution of each portion of said molded object so that the point, located on an extension of the position of the center of gravity of said molded object in the vertical direction, coincides with or approaches said virtual supporting portion.

17. The non-transitory computer-readable recording medium described in claim 12, wherein, in a case in which said molded object, having a movable portion, is made to stand by itself on a pre-designated supporting surface, said weight balance calculating comprises: a) obtaining each position of the center of gravity at the time when said movable portion is at a plurality of specific stopping positions; b) obtaining a specific position of the center of gravity in accordance with a predetermined calculating formula from the plurality of positions of the centers of gravity; and c) calculating a weight distribution of each portion of said molded object so that the point, located on an extension of the position of the center of gravity of said molded object in the vertical direction, is arranged inside an area surrounded by a line formed by connecting the outer circumference or peaks of said supporting surface.

18. The non-transitory computer-readable recording medium described in claim 12, wherein, in a case in which said molded object is made to stand by itself on a pre-designated plurality of supporting surfaces, said weight balance calculating comprises: a) obtaining each position of the center of gravity at the time when said molded object is made to stand on each supporting surface; b) obtaining a specific position of the center of gravity in accordance with a predetermined calculating formula from the plurality of positions of the centers of gravity; and c) calculating a weight distribution of each portion of said molded object so that the point, located on an extension of the position of the center of gravity of said molded object in the vertical direction, is arranged inside an area surrounded by a line formed by connecting the outer circumference or peaks of said supporting surface.

19. The non-transitory computer-readable recording medium described in claim 17, wherein said weight balance calculating comprises calculating the weight distribution of each portion of said molded object in such a manner that the point, located on an extension of the position of the center of gravity of said molded object in the vertical direction, coincides with or approaches the center position of said supporting surface.

20. The non-transitory computer-readable recording medium described in claim 12, wherein, in a case in which said molded object is suspended from a pre-designated single supporting point, said weight balance calculating comprises calculating the weight distribution of each portion of said molded object in such a manner that the point, located on an extension of the position of the center of gravity of said molded object in the vertical direction, coincides with or approaches said supporting point.

21. The non-transitory computer-readable recording medium described in claim 12, wherein, in a case in which said molded object is suspended from a plurality of supporting points designated in advance, said weight balance calculating comprises: a) obtaining, from said plurality of supporting points, one virtual supporting point with which said molded object is in a stable condition with respect to said specific supporting direction; and b) calculating a weight distribution of each portion of said molded object in such a manner that the point, located on an extension of the position of the center of gravity of said molded object in the vertical direction, coincides with or approaches said virtual supporting point.
